(19) United States
(12) Patent Application Publication
(10) Pub. No.: US 2012/0240062 A1
(43) Pub. Date: Sep. 20, 2012

(54) Text-based messaging application cloud

(75) Inventors: Greg James Passmore, Portland, OR (US); Russell Ikuo Okamoto, Beaverton, OR (US)

(73) Assignee: CELLY, INC., Portland, OR (US)

(21) Appl. No.: 13/420,546

(22) Filed: Mar. 14, 2012

Related U.S. Application Data
(60) Provisional application No. 61/452,607, filed on Mar. 14, 2011.

(51) Int. Cl. G06F 3/01; G06F 15/16

(52) U.S. Cl. 715/758

(57) ABSTRACT

This disclosure relates to systems and methods for providing an application services cloud based on text-based messaging that hosts a plurality of application services that enables applications to be designed and delivered in a simple, productive, and extensible user experience. The present disclosure transforms any device equipped with text-based messaging into a cloud computer, a thin client with connected access to cloud-hosted applications. The disclosure overcomes heretofore unsolved platform design and implementation challenges for text-based messaging applications such as issues of user interface constraints, security, service discovery, information filtering and tracking, platform integration and extensibility, and architectural scalability.

### CROSS-REFERENCE TO RELATED APPLICATIONS

This application claims the benefit of U.S. Provisional Application No. 61452607 filed Mar. 14, 2011.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Text-based messaging is a method of communication whereby textual character strings can be sent and received as messages. Messages can be exchanged between people or automated computer systems in order to communicate information or initiate commands. Common user interfaces for text-based messaging include email, text terminals, programming shells, Instant Messaging (IM), Internet Relay Chat (IRC), and Short Message Service (SMS). Desktop computers, video game consoles, electronic book readers, printers, televisions, and mobile phones are devices commonly equipped with text-based messaging capabilities.

Because of the ubiquity of text-based messaging user interfaces and devices, it is desirable to create an application services cloud that leverages text-based messaging as the underlying method of communication. Such an application services cloud would provide an easily accessible method and system for delivering a portfolio of rich application services—such as mobile social networking, search, alert tracking, news services, and games—to users with limited modality, low cost communication devices. By virtue of layering on top of popular text-based messaging interfaces, such an application services cloud would obviate the need for software downloads and installation, providing instant accessibility to rich application services for anybody with a text messaging-enabled device. Furthermore, such a text-based messaging cloud would provide a device-agnostic method of multi-user communication allowing users with limited modality devices and users with multi-modal devices such as GUI-based smartphones to communicate without the need for purchasing, downloading, or installing device-compatible communications software.

Building an application services cloud on top of text-based messaging interfaces, however, has been prevented by heretofore unsolved platform design and implementation challenges such as user interface constraints, security concerns, service discovery, information filtering and tracking, cloud integration and extensibility, and architectural scalability. What is needed, therefore, is a text-based messaging application services cloud that hosts a plurality of application services utilizing one of many text-based messaging interfaces in a way that overcomes these design and implementation challenges, providing a simple, productive, and extensible end-user application experience.

### BRIEF SUMMARY OF THE INVENTION

The present disclosure provides a system and methods for implementing a text-based messaging application services cloud. According to the present disclosure, a plurality of application services can run on the cloud utilizing text-based messaging as the underlying channel for communication with client connected devices. The present disclosure thus transforms any device equipped with text-based messaging into a cloud computer, a thin client with connected access to cloud-hosted applications. This application services cloud can be implemented using any underlying text-based messaging interface channel, such as but not limited to an SMS shortcode, Voice Over Internet Protocol (VOIP) longcode, an email address, or an instant messaging address. Accordingly, the present disclosure implements a system and methods that enable application services to be hosted in a way that makes it easy to navigate efficiently between a plurality of application services, add new application services, connect disparate groups into workflows, track message alerts of interest, browse and filter remote services such as the Internet or other networks, discover and rank new services and application content. Application services can be single user or multi-user applications including group collaboration and communication. The present disclosure provides novel user interface methods that reduce input manipulations, reduce the need to memorize commands, reduce message round-trips from input devices, reduce learning curve, maximize information density per message, maximize economy of interaction and compute resources (reducing data costs for user), enable extensibility, and adhere to industry best practices. From a platform infrastructure viewpoint, the present disclosure utilizes mobile devices to create a system and novel architectural methods that enables the service to scale as more applications, users, and devices interact via the cloud. Finally, the present disclosure provides a novel system and methods for a resilient, highly available group communication service based on ad-hoc networks and for routing messages between networks even when communication networks are segmented.

### BRIEF DESCRIPTION OF THE SEVERAL VIEWS OF THE DRAWINGS

FIG. 1. is a diagram of the user registration sequence used in an example embodiment of the present disclosure.

FIG. 2. is a diagram of the service promotion sequence used in an example embodiment of the present disclosure.

FIG. 3. is a diagram of the direct messaging sequence and the block user sequence used in an example embodiment of the present disclosure.

FIG. 4. is a diagram of the create channel sequence used in an example embodiment of the present disclosure.

FIG. 5. is a diagram of the change channel type sequence used in an example embodiment of the present disclosure.

FIG. 6. is a diagram of the user location checkin sequence used in an example embodiment of the present disclosure.

FIG. 7. is a diagram of the watch channel sequence used in an example embodiment of the present disclosure.

FIG. 8. is a diagram of the channel derivation sequence used in an example embodiment of the present disclosure.

FIG. 9. is a diagram of the QAChannel creation and usage sequence used in an example embodiment of the present disclosure.

FIG. 10. is a diagram of the PollChannel creation and usage sequence used in an example embodiment of the present disclosure.

FIG. 11. is a diagram of the AutoChannel creation and usage sequence used in an example embodiment of the present disclosure.

FIG. 12. is a diagram of the WebChannel sequence used in an example embodiment of the present disclosure.

FIG. 13. is a diagram of the WebChannel claim sequence used in an example embodiment of the present disclosure.

FIG. 14. is a diagram of an alarm creation sequence via an EigenChannel in an example embodiment of the present disclosure.

FIG. 15. is a diagram of the channel recycling message used in an example embodiment of the present disclosure.

FIG. 16. is a diagram of the MultiText disambiguation sequence used in an example embodiment of the present disclosure.

FIG. 17. is a diagram of the direct channel messaging sequence used in an example embodiment of the present disclosure.

FIG. 18. is a diagram of a TextWizard sequence used in an example embodiment of the present disclosure.

FIG. 19. is a diagram of an abbreviation and aliasing comparison used in an example embodiment of the present disclosure.

FIG. 20. is a diagram of a channel parsing sequence and an aliasing example used in an example embodiment of the present disclosure.

FIG. 21. is a diagram of the Pound mode used in an example embodiment of the present disclosure.

FIG. 22. is a diagram of the Slash mode used in an example embodiment of the present disclosure.

FIG. 23. is a diagram of the Bang mode used in an example embodiment of the present disclosure.

FIG. 24. is a diagram of the Boomerang mode used in an example embodiment of the present disclosure.

FIG. 25. is a diagram of how example devices may be arranged as an Ambient Cloud in an example embodiment of the present disclosure.

FIG. 26. is a diagram of example devices that may be connected together and used in an example embodiment of the present disclosure.

FIG. 28. is a diagram showing group communication in a MANET.

FIG. 29. is a diagram showing how physical movement of a user from one MANET to another MANET enables data routing.

FIG. 30. is a diagram of the process of MultiText.

FIG. 35. is a diagram showing a subprocess of MultiText.

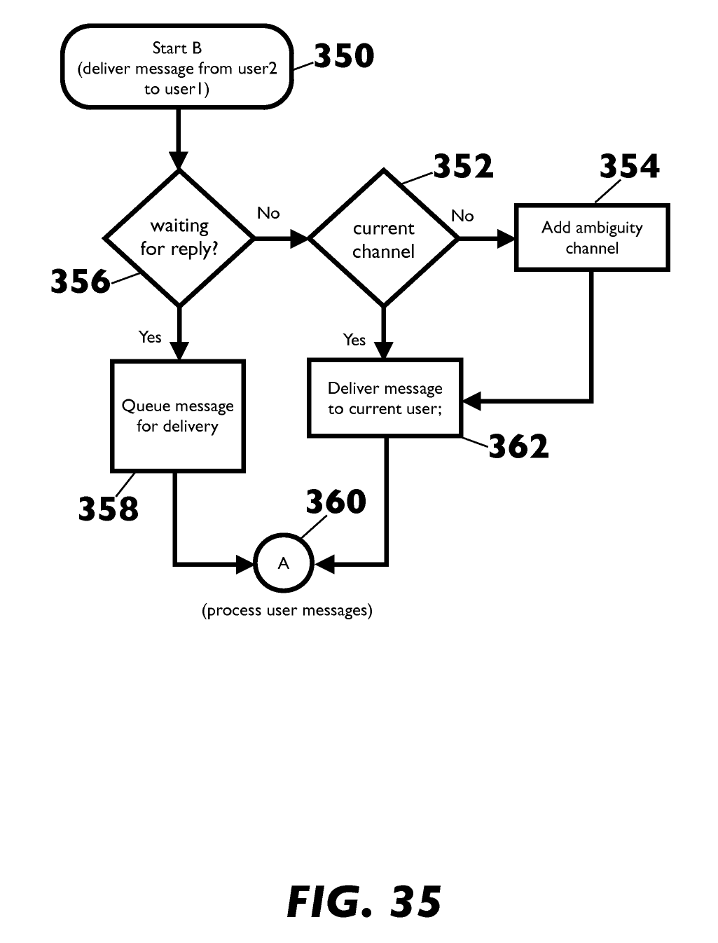

FIG. 38. is a diagram showing a subprocess of MultiText.

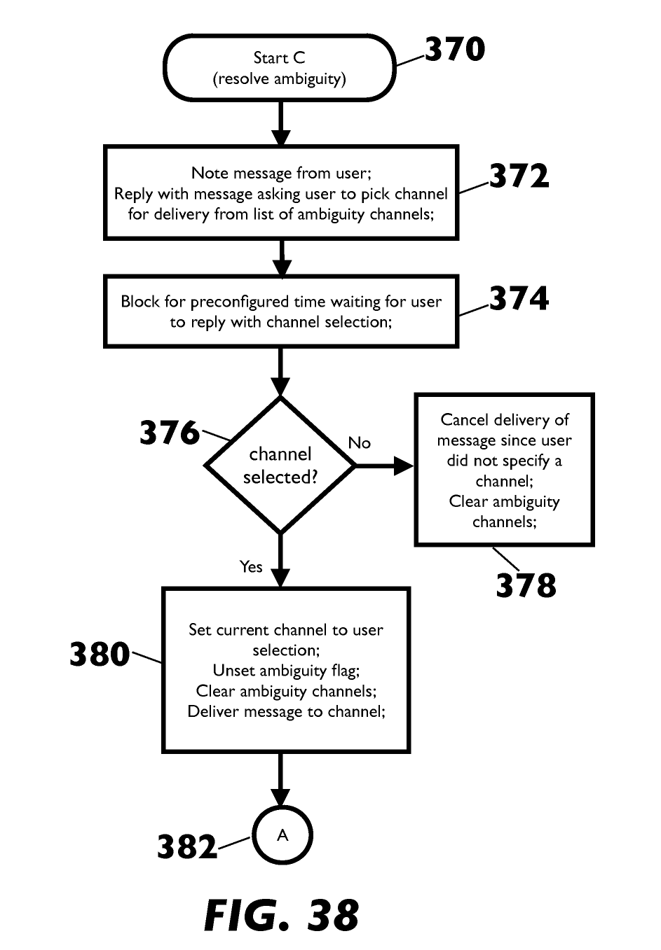

FIG. 40. is a diagram of how TrackChannels organize into workflow networks.

FIG. 50. is a diagram showing the TaskTag system of group collaboration in operation.

### DETAILED DESCRIPTION OF AN EXAMPLE EMBODIMENT

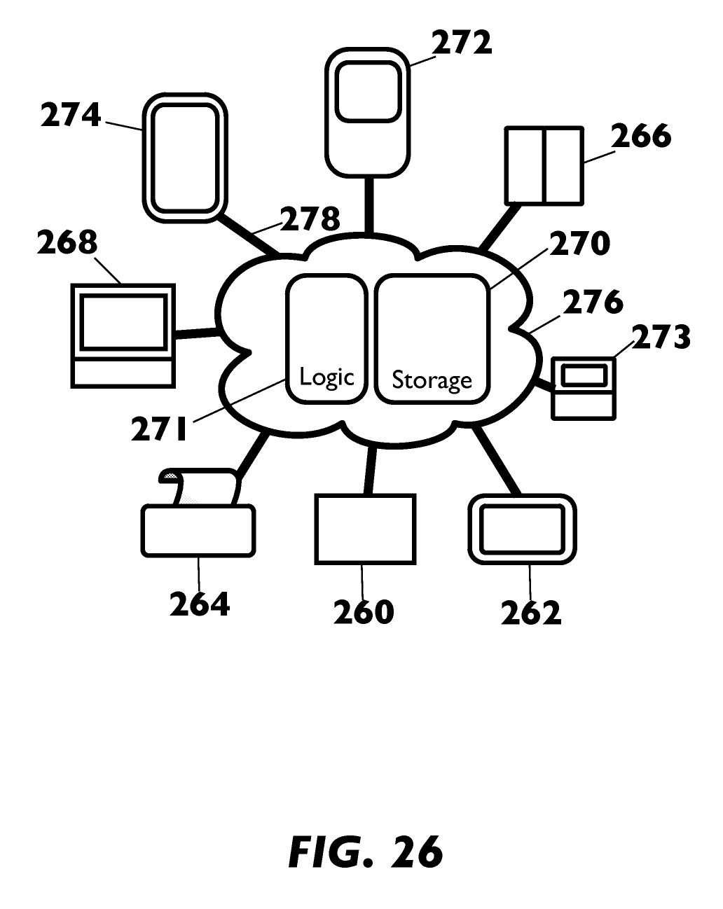

An example embodiment of the present disclosure utilizes an SMS (Short Message Service) shortcode as the underlying text-based messaging interface. An SMS shortcode is a five or six digit telephone number dedicated for business use rather than personal communication. As shown in FIG. 26, users skilled in the prior art will recognize that other text-based messaging interfaces, including but not limited to, Instant Messenger, Internet Relay Chat, email, and command-line interfaces embedded into devices like televisions 260, game consoles 262, printers 264, electronic books 266, desktop 268 and portable 273 computers could similarly be utilized as embodiments of the present disclosure. The present disclosure enables mobile devices—including but not limited to featurephones 272 and smartphones 274—to interact with an SMS shortcode to access an application services cloud 276 with centralized compute 271 and storage 270 via a network 278 defined herein as “Celly”.

### User Identity

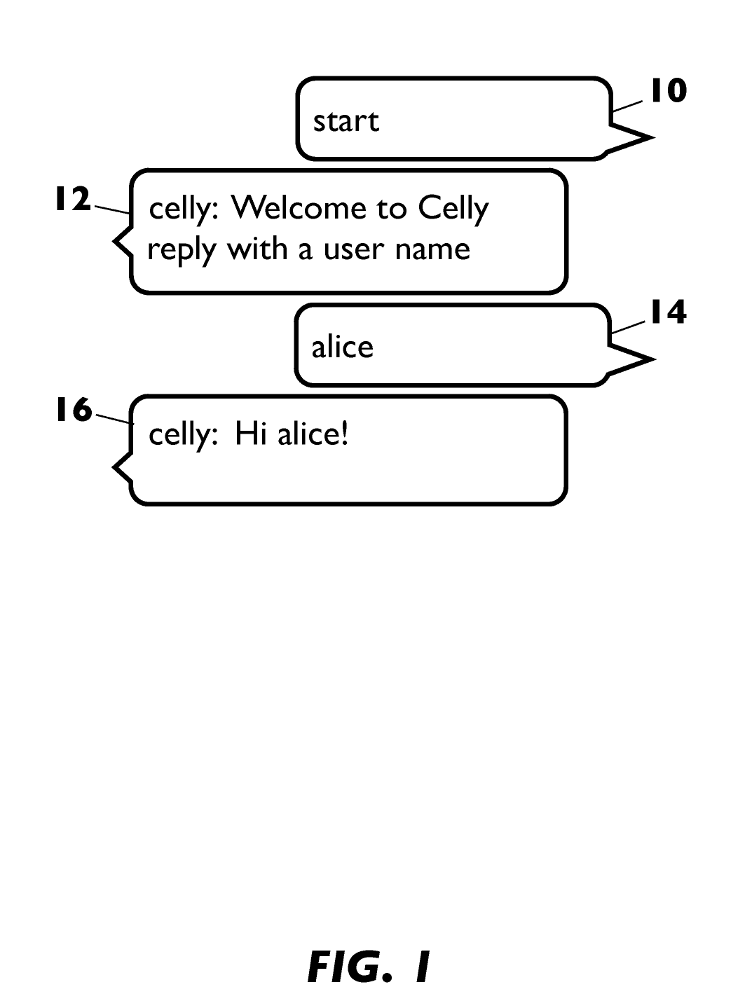

As shown in FIG. 1, a user first interacts with Celly by texting “START” 10 to an SMS shortcode associated with Celly. Upon receiving the “START” message, Celly replies with a text message asking the user to choose a unique user identity 12. After the user texts back a unique user name (in this case “Alice”) 14, Celly sends a text message to the user confirming their identity has been registered 16.

Privacy of phone numbers and message content A distinguishing feature of Celly from prior art embodiments is that in the present disclosure a user's phone number is always kept private. That is, Celly keeps a user's phone number hidden from other users to maintain privacy and minimize cyberbullying. Furthermore, users may specify that Celly encrypt messages for storage archival purposes. In this way, users may feel reassured that messages stored within Celly cannot be read by Celly personnel and can only be decrypted and read by the message sender and receivers. As an example encryption scheme for message archival, Celly users may utilize private/public key cryptography methods or advanced homomorphic encryption methods.

### Promotion

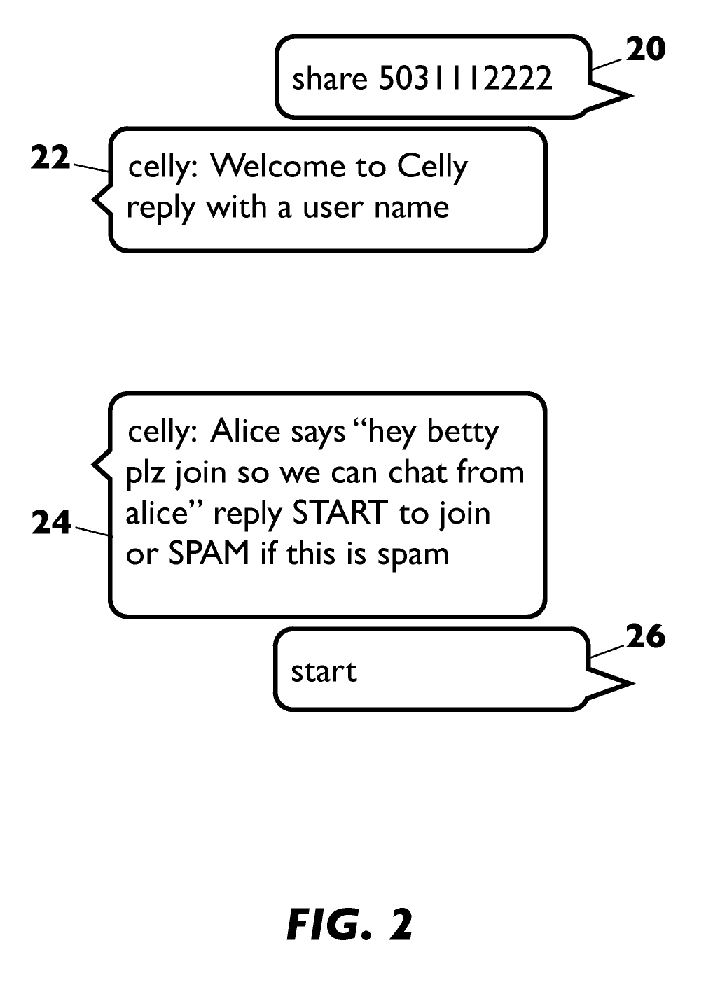

A user may voluntarily promote Celly, encouraging a friend or family member to join Celly, by texting “SHARE” 20 followed by a recipient's phone number (previously known by the sender). Celly then sends the recipient's phone number a text message asking them to join Celly. As shown in FIG. 2, the text message includes the sender's username—but not the user's phone number—as well as a short phrase selected by the sender to help the recipient identify the identity of the sender 24. To join Celly, the recipient simply texts the “START” message to Celly's shortcode 26. To discourage users from spamming other users via this voluntary promotion process, Celly enables recipients to alternatively report the sender's message as spam. In this case, Celly degrades the sender's capacity to deliver additional SHARE messages by preventing the user from sending new SHARE messages until a predetermined time period has elapsed or until the sender's previous SHARE messages result in a predetermined number or percentage of subsequent START messages invoked by recipients.

### Direct Messaging

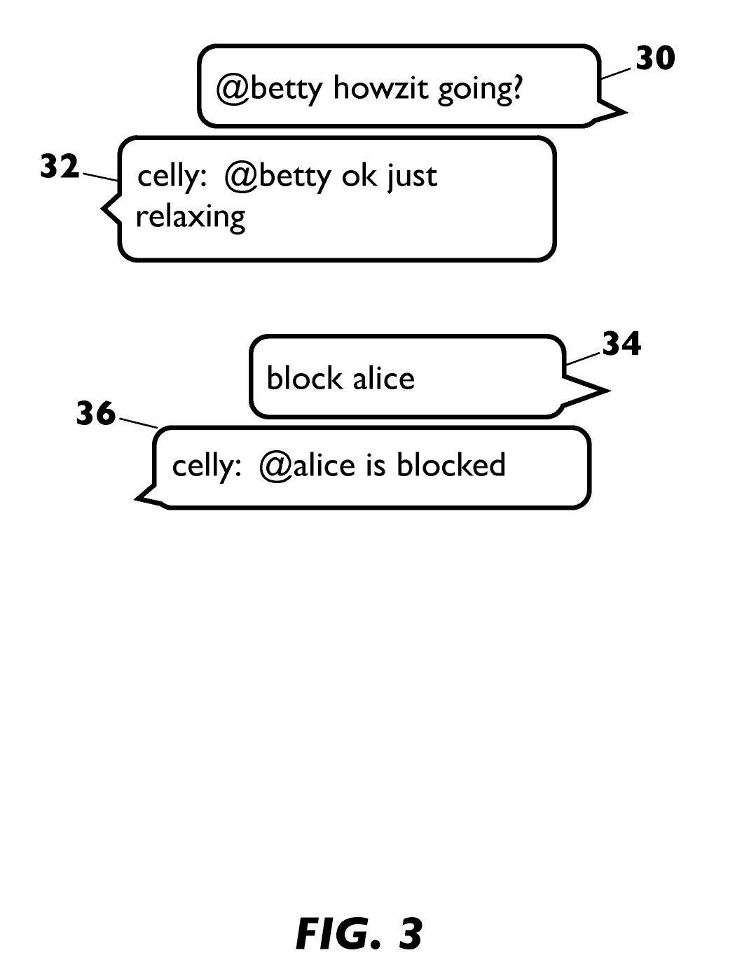

As a cloud service, Celly user identity management enables individuals to securely, i.e. without disclosing phone numbers, exchange private text messages. As shown in FIG. 3, a user can send another user a direct message with a predetermined messaging syntax, e.g., “@betty” 30. Users can block message senders 34, rank other users, and retrieve lost passwords. Hosted application services can reuse Celly's built-in user management services to implement application-specific features. Celly itself utilizes user identity to track cross-application participation metrics and drive game mechanics such as cloud-wide leaderboards and customized achievement quests.

### Channels

Beyond single user identity management and one-to-one user communication, the present disclosure implements a system and methods for multi-user communication known as “channels”. Channels are text messaging groups that broadcast text messages among channel members. Channels allow users to create a plurality of independent social networks for disparate groups making-up their social graph. For example, a user might create one or more channels for direct family members, channels for their closest friends, and channels for clubs they belong to.

For a text-based messaging cloud, channels are a fundamental service enabling a host of value-added application services based on group communication. Such application services include, but are not limited to, school and community alerts, citizen journalism reporting, multi-player games, event feedback, disaster relief coordination, public safety services, neighborhood watch, local area classified services, question and answer networks, mobile banking, microcredit services, and business to consumer services.

### Creating and Joining

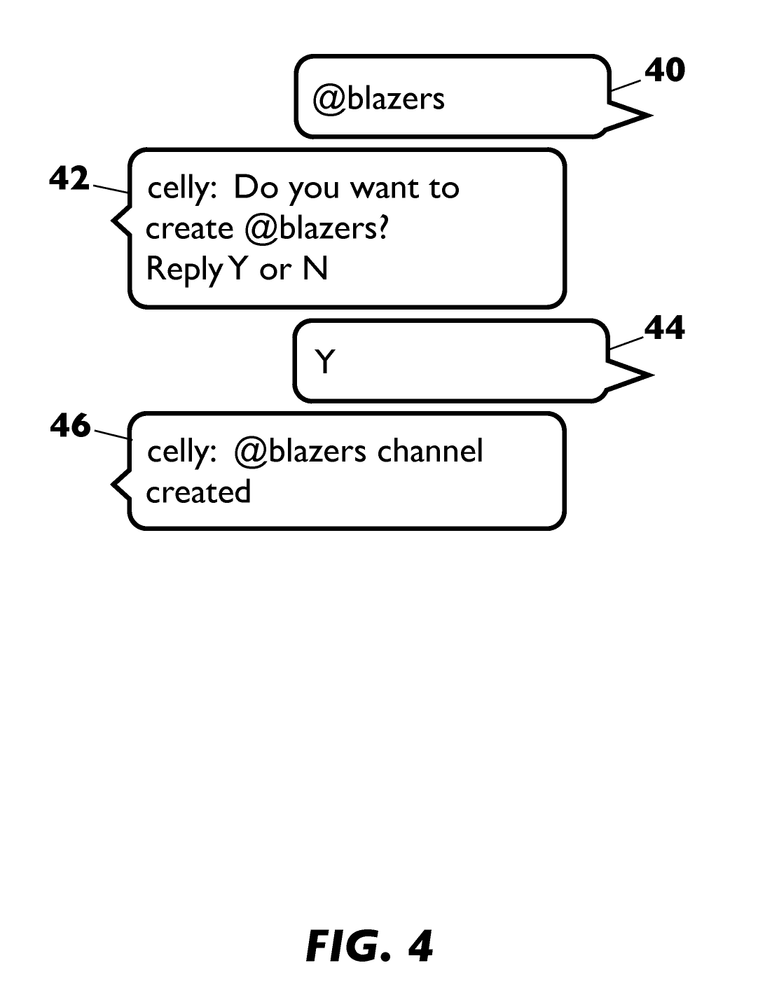

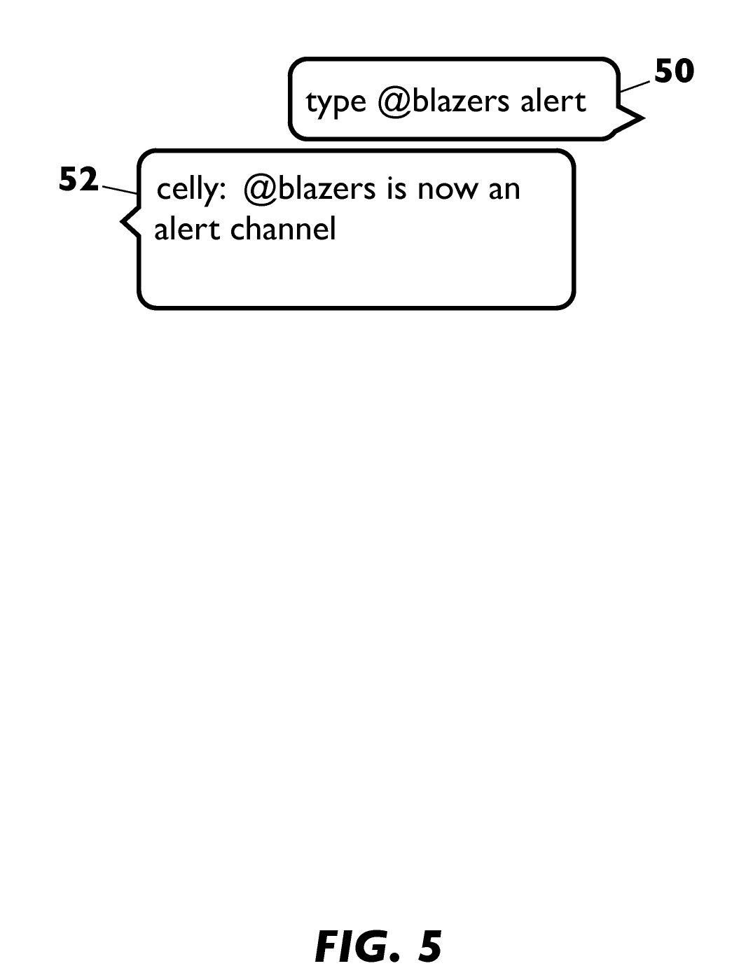

To create FIG. 4 or join FIG. 5 an channel, a user simply texts a unique channel name to the Celly shortcode. If the channel name does not exist, Celly asks the user if the channel should be created. As shown in FIG. 4, the user Alice asks Celly to create the channel named “blazers” 40. To search for a channel, a user can simply text the channel name and Celly returns the channel or a list of channels with similar names. The user can then select from the list or create the channel if there is no channel name match 42, 44, 46. A key feature of the present disclosure is that channels enable instant, device-agnostic group communication between users with different devices, requiring no software download or installation.

### Privacy Types

Channels of the present disclosure enforce a range of privacy policies. The default policy is “Invite-only” privacy which permits only people invited or explicitly approved to participate in the channel. “Password” privacy requires users to enter a password to join the channel. “Public” channels are deliberately open to anybody and require no authentication.

### Alternative Email-Based Authentication

By default users must possess a mobile phone number with an SMS service plan to register a username and participate in Celly. In some cases, however, users may not own a cellphone or may not have a text messaging service plan. To permit such users without a mobile phone/plan to join a channel, the present disclosure provides a novel method of user authentication: a channel owner specifies an email address, password, and an optional username that an invited recipient may use for registration purposes. When an email message is received by Celly with content that includes the matching password, Celly registers the user with the optional username (or an automatically generated username) and the new user is added as a member to the channel. Users registered via this procedure, however, have reduced privileges in Celly, e.g., they cannot create their own channels or invite additional users.

### Channel Operating Modes

Channels provide different types of channel operating modes. “Chat” channels permit every member to send and receive messages. “Alert” channels enable one person to broadcast messages to all other members. “Info” channels enable anybody—joining as a member is not required—to ping the channel and receive a reply with information customized by the channel owner, e.g., an SMS coupon. “Feedback” channels let anybody send messages to the channel and these messages are only seen by the channel owner. “Curated” channels let one or more curators approve or deny messages from any member before rebroadcasting the message to all members. As shown in FIG. 5 channels can be changed by the channel owner at any time by invoking the “TYPE” command 50.

### Metadata Including Location

Channels contain metadata to identify the topic of a channel. For example, a local high school soccer team called @wildcatssoc might define the word “soccer” as channel metadata. Geographical information such as zipcode may also be used as metadata for a channel. In this way, users searching for channels of interest can triangulate to channels based on location, metadata keywords, or channel name.

### Channel Innovations

The present disclosure further enchances basic channel use cases with the following useful, novel, and non-obvious innovations: CommunityChannels, TrackChannels, QAChannels, PollChannels, AutoChannels, and WebChannels.

### CommunityChannels

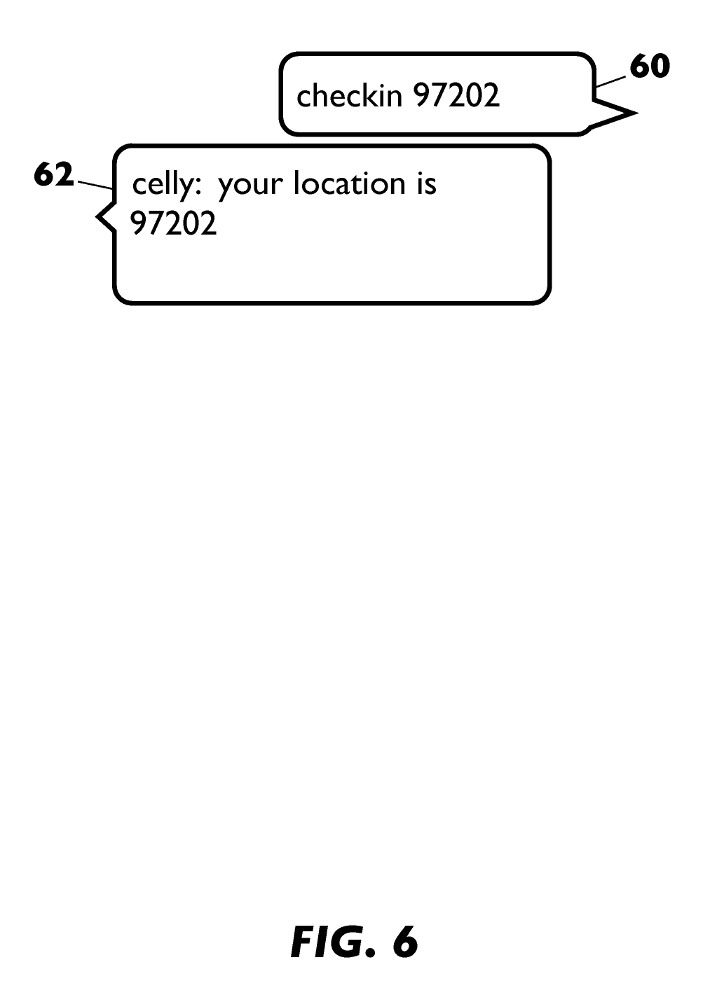

To stimulate hyperlocal social networking, the present disclosure hosts built-in platform channels known as “CommunityChannels”. As shown in FIG. 6, these channels let users “checkin” 60 to an area and post neighborhood-specific news, events, issues, and classified alerts to people within the hyperlocal area. Celly predefines the following channels:

### @NEWS

### @EVENTS

### @ISSUES

### @FORSALE

### @HOUSING

### @SERVICES

### @JOBS

### @PERSONALS

### @WANTED

### @FREE

### @COUPONS

In addition to Celly user replies, CommunityChannels aggregate messages from external Web services like Craigslist and Twitter. Classified items posted to Craigslist or Twitter, e.g., are continuously monitored by Celly. When matches are found in these services, text message alerts are delivered to Celly users. The present disclosure utilizes a novel method to glean CommunityChannel information from popular social networking services like Twitter: Celly monitors social network traffic and detects messages posted about a particular location that also include hashtags relevant to a specific CommunityChannel. For example, a tweet from Portland, Oreg. with a hashtag of “#forsale” would be culled by Celly as traffic on the @FORSALE CommunityChannel.

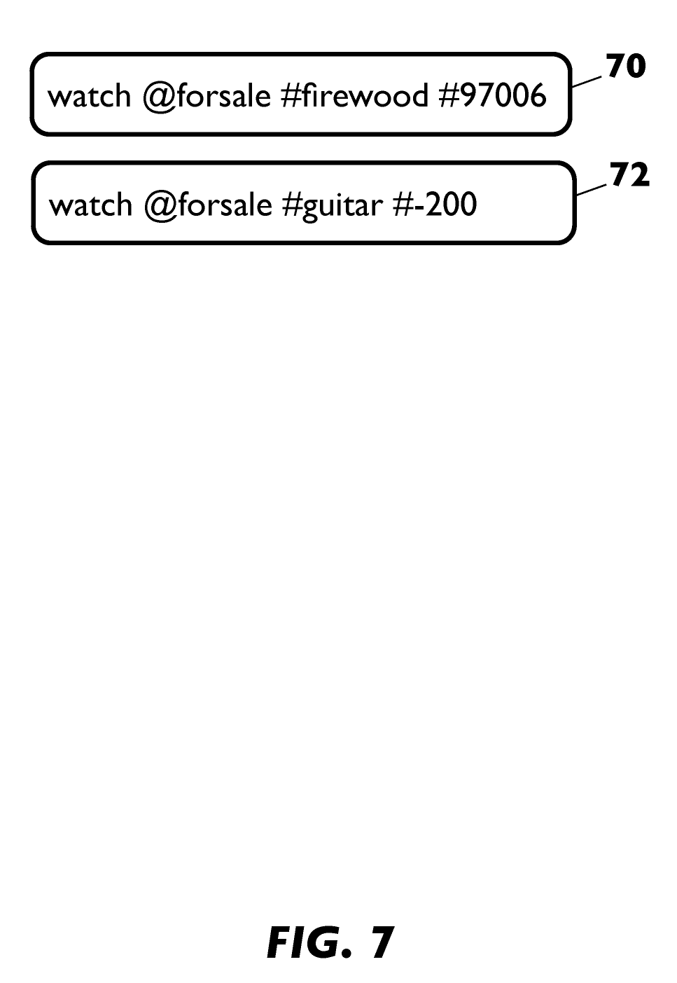

Users track these built-in platform channels for messages of interest by filtering for keyword and location criteria, e.g., zipcode via a “WATCH” command. As messages are posted to these channels, Celly continuously queries the channel stream and texts recipients when matches occur. For example, as shown in FIG. 7, to monitor the @FORSALE channel for firewood in the 97006 zipcode, a user texts, “watch @FORSALE #firewood #97006” 70.

### Hashtags Semantics

The expressions “#firewood” and “#97006” 70 are well-known as “hashtags”. Multiple hashtags can be used to refine a CommunityChannel on behalf of a user. The present disclosure introduces methods that enhance the power of hashtags in novel ways: Rather than simply matching keywords, Celly parses hashtags for semantic type information, matching well known patterns such as location information. Five digit zipcodes, e.g., are automatically parsed into “geotags”. As shown in FIG. 7, Celly also refines basic keyword hashtag syntax allowing users to conveniently specify “less than” or “greater than” price filtering criteria by doing, e.g., “#−200” 72 or “#+200” respectively. These specialized hashtags are known as “pricetags”. The present disclosure enables users to embed regular expressions into hashtags, e.g., a regular expression like “#books.*” defined within a hashtag matches messages containing words like “books”, “bookshelf”, and “bookstore”. Hashtags may include phrases by specifying multiple words within two“#” symbols, e.g., “#civil rights#”

### TrackChannels

An example embodiment of the present disclosure enables users to generically use hashtags to track data on any Celly channel type, not just CommunityChannels, and to create new channels by combining one or more existing channels. These filtered, derivative channels known as “TrackChannels” can themselves be filtered and merged into new TrackChannels. In addition to Celly channels, TrackChannels can also be created on non-Celly data stream resources, including but not limited to, Web pages, RSS and social networking feeds, IRC channels, XMPP multi-user chats, instant messaging streams, sensor data networks, and other shortcode services.

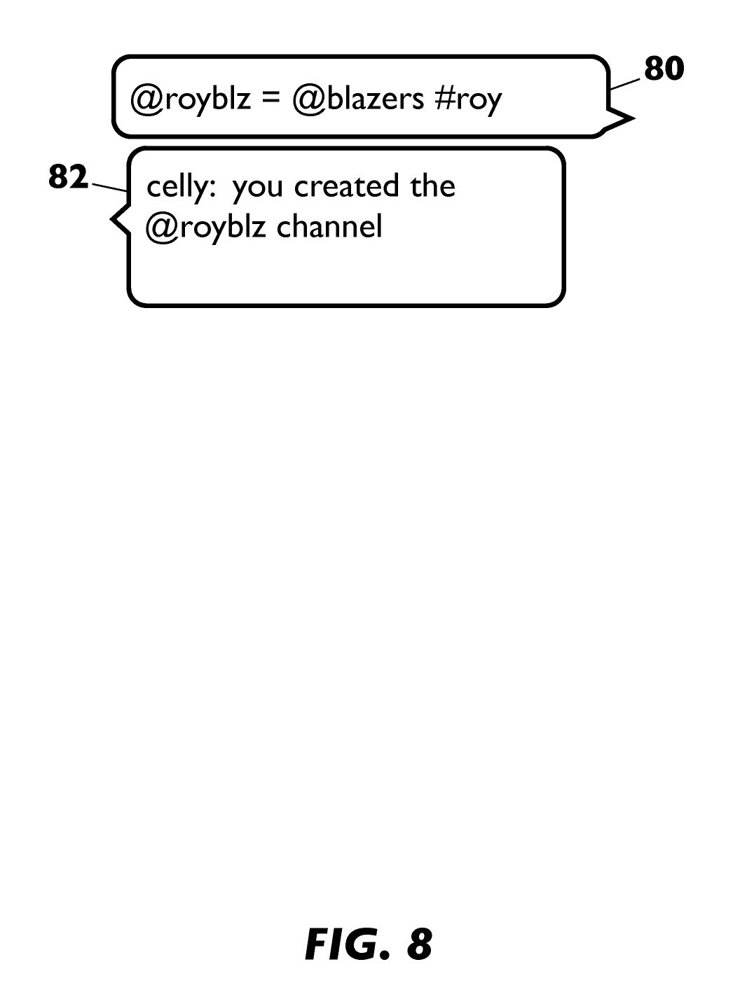

Celly defines novel methods to facilitate TrackChannel creation. As shown in FIG. 8, a user instantly creates a TrackChannel by texting a predetermined command syntax: “@royblz=@blazers #roy” 80. This derivative TrackChannel can then be published in a cloud wide services directory so that other users can subscribe to alerts from the TrackChannel. Declaring derivative TrackChannels is simple due to the fact that channels have unique channel names and that channel names share a common namespace. If channels were not named (as in VOIP longcode approaches), TrackChannels could not be easily remembered, recognized, and uniquely referenced for discovery, composition, and derivation purposes.

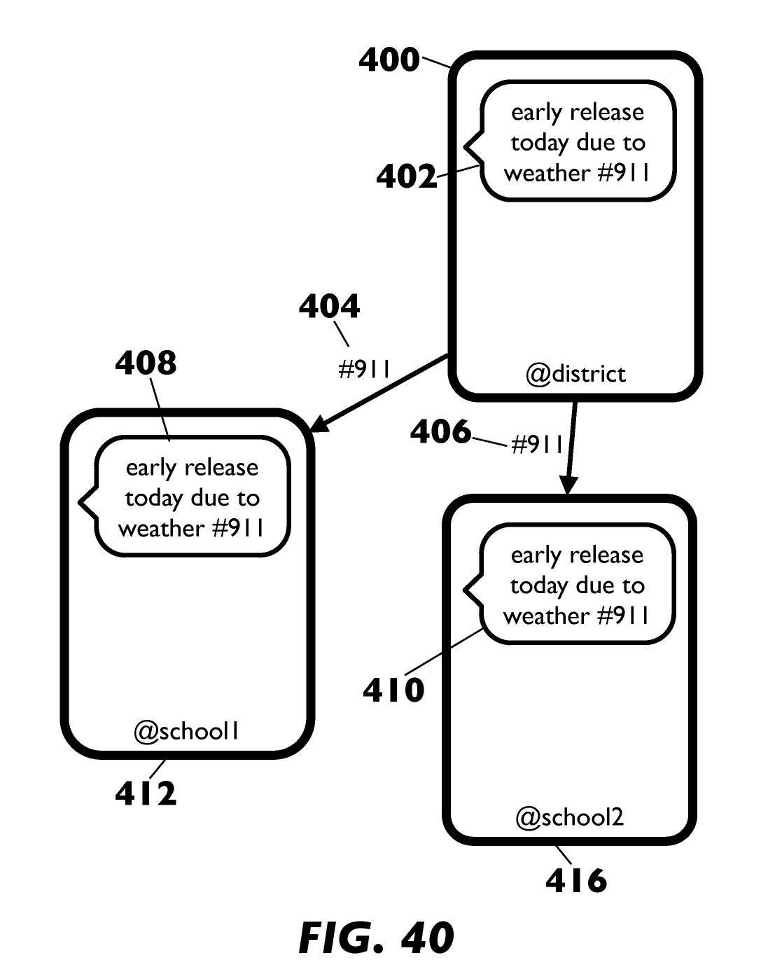

Accordingly, TrackChannels are fundamentally based on user opt-in. Criteria defining each TrackChannel is precisely targeted to what the subscriber of the TrackChannel is interested in. When matches occur, Celly sends text-based alerts containing the matched information to the user. In this way, Celly delivers “autonomic search”, i.e., prospective search for future conditions, events, and data based on user interests. The universe of TrackChannels thus defines a collective user-based “Interest Graph”. TrackChannels based on the Interest Graph produce realtime insight beyond the capabilities of prior art, retrospective search engines like Google. Analytics about TrackChannels—e.g., the popularity of particular hashtags—also reveals useful, novel, and non-obvious data that can be monetized by Celly in a plurality of ways. For example, Celly can enable precise placement of advertisement for sellers based on targeted user interests. From a workflow perspective, by providing automatic, semantic routing of data between channels, TrackChannels enable loosely coupled workflows across channels according to user-defined folkosonomies: channels can pre-define agreed-upon vocabularies that when included in messages cause such messages to be automatically routed to, or “tracked by”, subscribing TrackChannels. In this way, links between channels can occur via semantic keyword tags organizing many channels into overall communication networks. An example communication network created by TrackChannels is illustrated in FIG. 40. A source channel 400 and a plurality of destination TrackChannels 412, 416 are linked according to user-defined hashtags 404, 406 or keyword filters. Text-based messages 402 that match the tracking criteria are then routed automatically 408, 410 from the source channel 400 to the TrackChannels 412, 416. Because TrackChannels flexibly link together into a network based on hashtags, these TrackChannels are also referred to in Celly as “hashlinks”.

### TaskTags

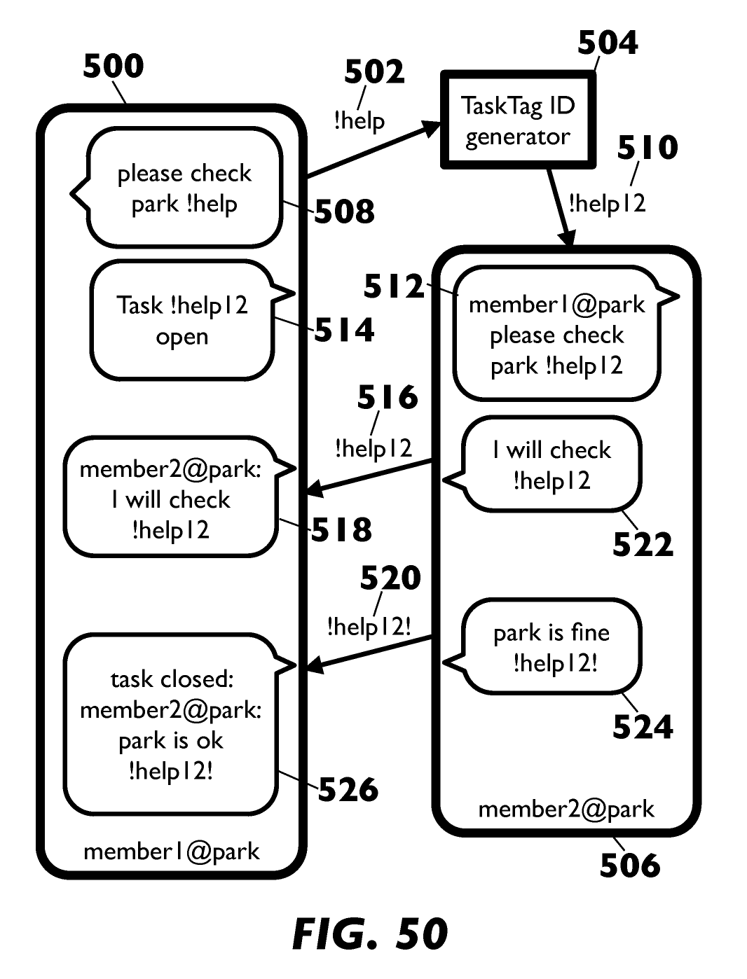

To further enhance workflow scenarios enabled by text-based messaging channels, Celly defines a novel system for lightweight group collabortion. Leveraging the familiarity of hashtags, the system utilizes an invention called “tasktags” that predefines a task symbol like “!”. As the system flow is depicted in FIG. 50, tasks are announced by prefixing a keyword with the task symbol 502. When a new task is announced, the system generates 504 a unique sequence identifier that is appended to the original keyword forming a unique label or tasktag 510 that facilitates tracking by users. The system announces the task is open 514 to the channel and appends the new tasktag to the original message 512. As users confer about tasks by sending channel messages 522, they can include the particular tasktag in their messages 516. A user closes a task by sending a message containing the tasktag and suffixing it (closing it) with the task symbol 524. The system then observes the tasktag is closed and sends a completion message to the channel announcing that the task is closed 526. To reopen a task, a user can simply send another message with the tasktag but with the suffixed task symbol elided.

### QAChannels

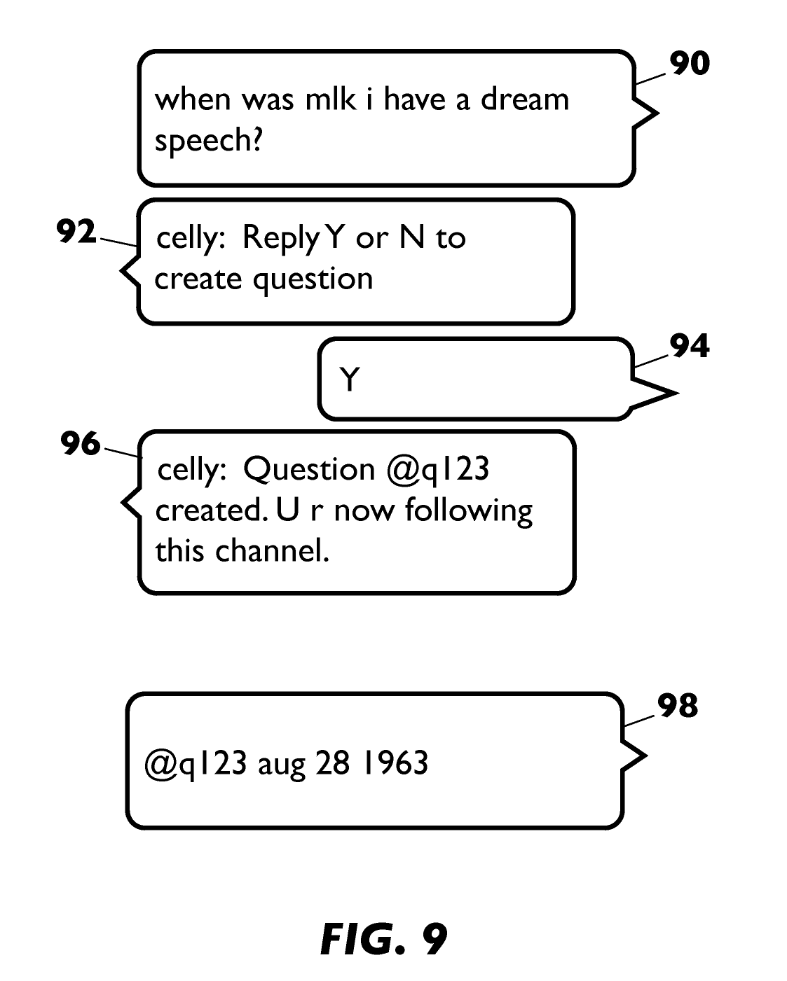

Another novel channel type introduced by the present disclosure is “QAChannels”. These are public channels that let users ask, follow, and reply to free form questions. As shown in FIG. 9, a user creates a QAChannel by simply texting a question to the Celly shortcode, “when was mlk i have a dream speech?” 90. A question follows a predetermined syntax, e.g., a message that ends in a “?” character. When a question is received, Celly returns a list of answers if available. In no answers are available, then Celly asks the user if a QAChannel should be created 92. If the user replies Y 94, then Celly creates the channel along with a unique channel name, e.g., “@q123”, and automatically subscribes the user as a follower of the channel 96. To help specify the context of a question, users may include metadata like hashtags, geotags, and pricetags associated with their question. Users reply to QAChannels in the same was as to any channel, by prefixing a message with the channel name, “@q123 aug 28 1963” 98.

### PollChannels

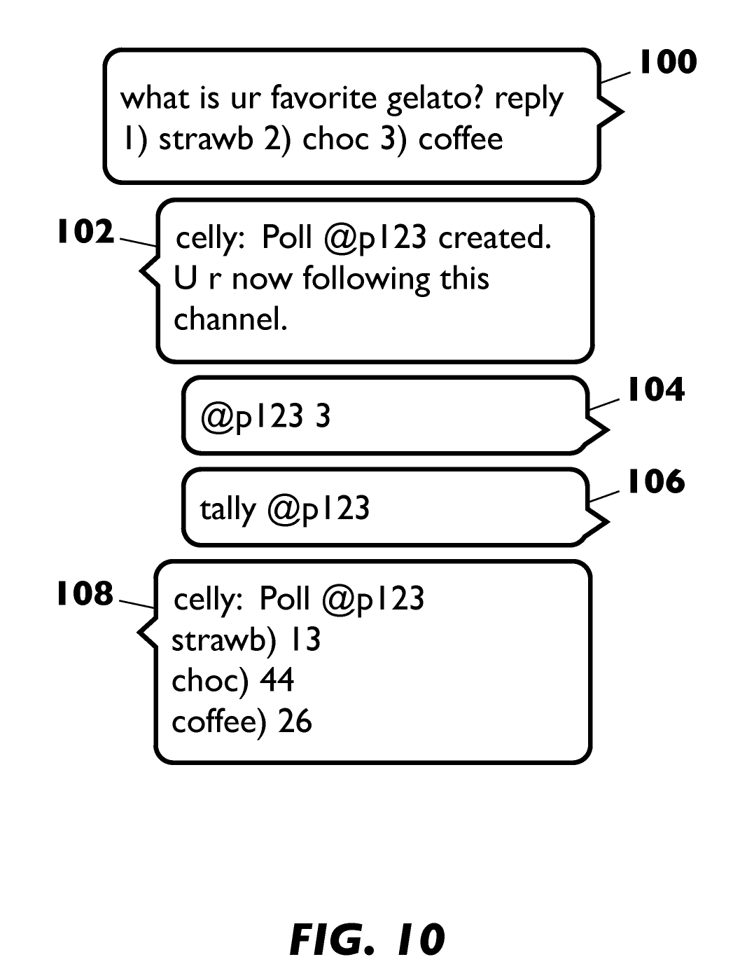

The present embodiment introduces novel methods for utilizing channels for polling/voting. As shown in FIG. 10, by texting or emailing Celly a message with a predetermined syntax, users can directly create a “PollChannel”. PollChannels follow a simple syntax whereby a poll question suffixed by a “?” is followed by multiple choice answers each prefixed by a numeral or letter: “what is ur favorite gelato? reply 1) strawb 2) choc 3) coffee” 100.

To define polls where the question and multiple choice answers span more than a single text message, users may alternatively send a predetermined text message command—e.g., “Poll”—to initiate an interactive PollChannel definition process. In this process, Celly first asks the user to reply with a poll question. After receiving the poll question, Celly asks the user to reply with a separate text message for each multiple choice answer. Celly finalizes this process by creating a unique channel name, e.g., “@p123”. Users reply to PollChannels in the same was as to any channel, by prefixing a message with the channel name, “@p123 3” 104. Celly tallies poll replies (votes) enabling the channel owner to view results 108 with a predetermined text messag command—e.g., “tally @p123” 106.

### AutoChannels

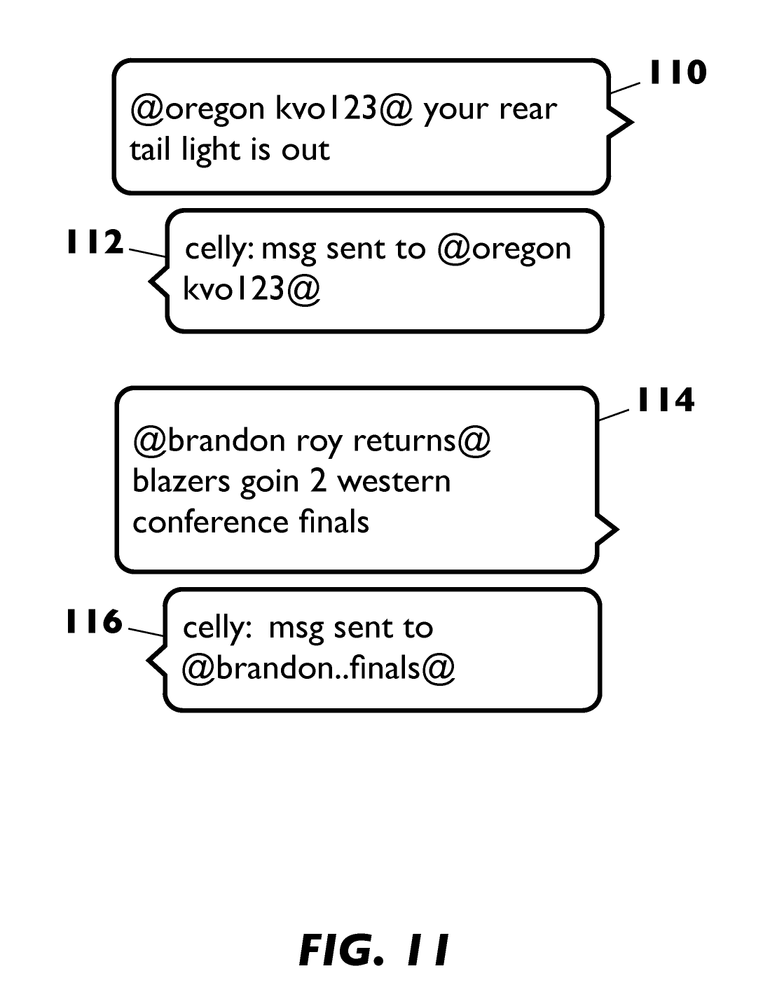

Beyond single keywords as channel identifiers, novel systems and methods of the present disclosure permit channels based on multi-word public identifiers or textual descriptions appearing in or associated with digital and non-digital media. Such channels, known herein as “AutoChannels”, have Public privacy policy and are designed to let users target messages to any entity addressable by a common public identifier or phrase—e.g., a newspaper headline, a television show name, a book ISBN number, a building or home address, etc. As shown in FIG. 11, a user may target a message to a driver of a car by creating an AutoChannel specifying the car's license plate number 110. Similarly a user may target a message to a homeowner by utilizing the homeowner's street address as the identifier for an AutoChannel. AutoChannels facilitate communication between users who may have fleeting or frequent interactions, e.g., interactions between anonymous strangers who do not know one another by name, but only perhaps by association with a particular context like a shared venue. A user may create an AutoChannel targeting a description of a person seen at a given time, place, and setting like “girl reading camus at pdx library last night”. Likewise, an AutoChannel could be created on behalf of media resources like novels and magazine articles enabling readers to instantly participate in group chat about stories and essays of interest. The sender of an AutoChannel message may choose to be anonymous, hiding their Celly username, or choose to reveal their username including an optional description. On the receiving side, there are no guarantees that AutoChannel messages are read by the sender's targeted recipient; however, potential recipients can choose to search and “follow” one or many AutoChannels they feel may be potentially targeted for them.

### AutoChannel Syntax

Celly introduces novel syntax for allowing users to directly create AutoChannel discussions: As shown in FIG. 11, an AutoChannel identifier can be created by specifying a unique phrase bookended by “@”s, e.g., “@brandon roy returns@ blazers goin 2 western conference finals” 114. Compared to single keywords as practiced in prior art, by enabling phrases to be specified as channel identifiers, Celly dramatically expands the channel namespace creating more channel identifier options for users since permutation of phrases made out of single keywords is virtually limitless. Furthermore, by enabling the use of phrases as identifiers, channel creators can select channel identifiers that exactly match their real world slogans or advertising copy, improving legibility and brand-recognition for call-to-action campaigns. A phrase-based channel identifier “Just do it”, e.g., can be simpler for an end user to read and recognize than a single word, whitespace-elided identifier like “justdoit”.

### WebChannels

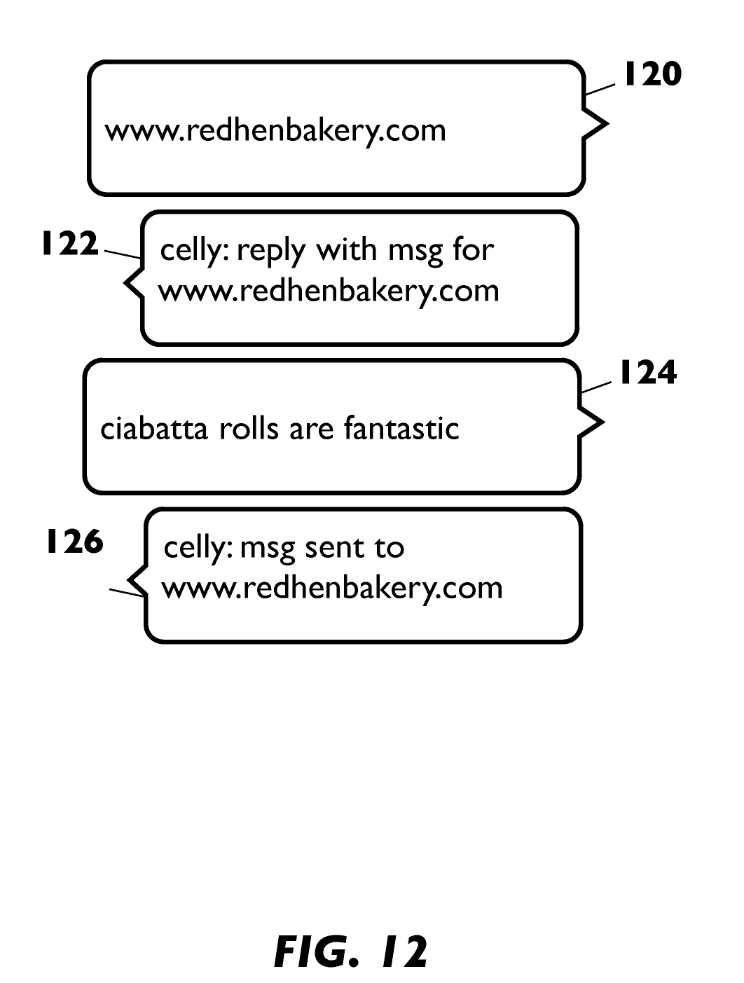

As another innovation beyond basic channel, this embodiment of the present disclosure lets users create group communication channels associated with Web Uniform Resource Identifiers (URI). Such channels known in Celly as “WebChannels”, enable users to participate in group discussions centered around any Web site. As shown in FIG. 12, a user creates a WebChannel by specifiying a URI, in this case “www.redhenbakery.com” 120. The user can then send messages to the WebChannel providing such information like customer feedback 124.

### Claiming a WebChannel

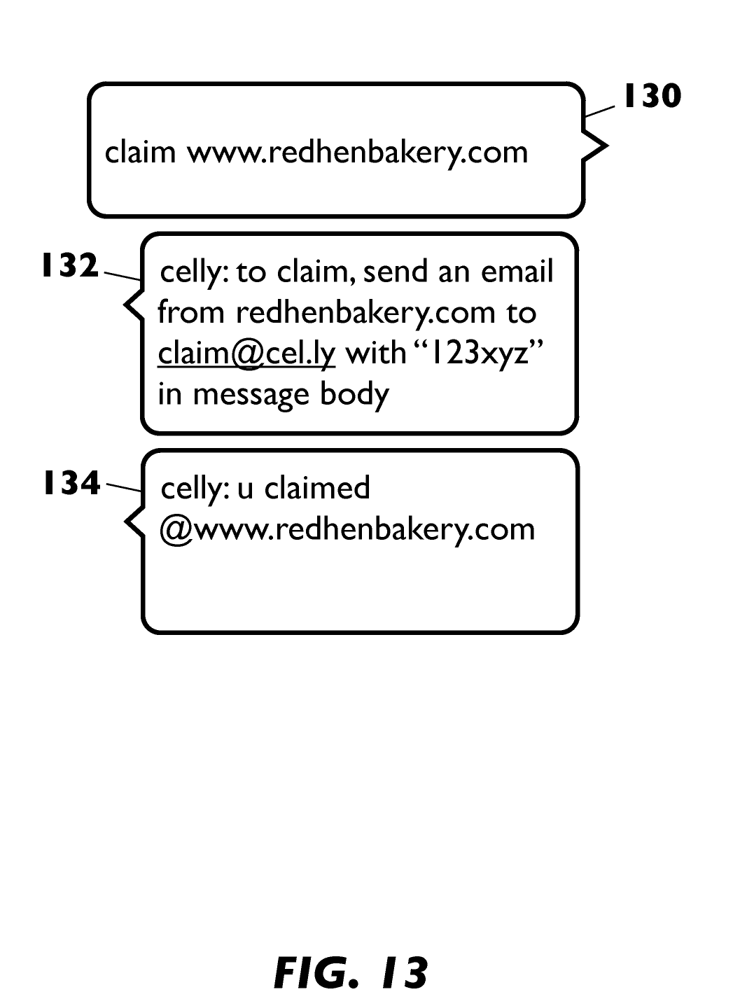

Due to the open nature of WebChannels, any user can potentially litter a WebChannel with spam or abusive messages. Therefore, as a way of controlling the quality of message content, the present disclosure provides novel methods for “claiming” WebChannels. When a channel is claimed, Celly confers channel ownership to a user so the user may control, review, and censure messages posted to the channel. In this way, the owner may elide spam and undesirable messages. To claim a WebChannel, as shown in FIG. 13, a user texts “CLAIM” followed by the WebChannel name 130. Celly responds with a one-time pad “claim token” 132. In order to prove provenance over the WebChannel domain, the user must then send an email message to Celly from the domain associated with the WebChannel along with the claim token. When Celly receives this email, the user is conferred channel ownership and may fully manage the channel—e.g., configure privacy policy, channel type, and membership 134. As an even more secure method of determining provenance, users can create a predetermined Web page hosted on the WebChannel domain which is then validated by Celly.

### EigenChannels

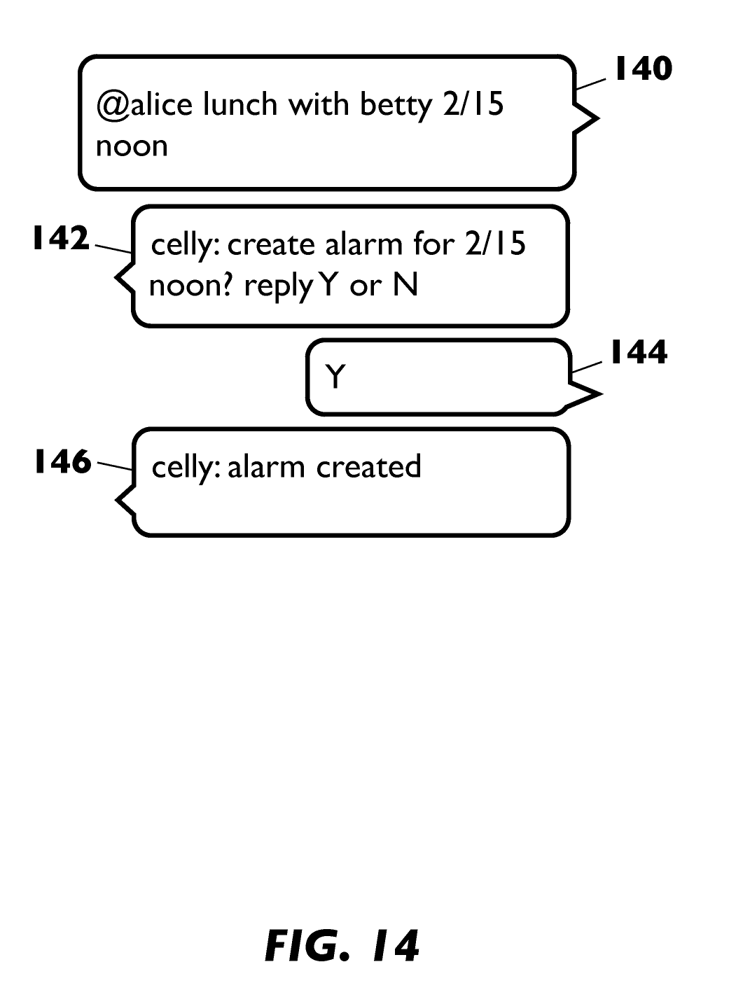

Celly “EigenChannels”, so-called because the are utilized only by a single user—provide a functional array of personal productivity services including, but not limited to, calendaring, note-taking, alarms, language services like dictionary and translation, and mathematical calculations and conversions. As shown in FIG. 14, users can text to a predefined EigenChannel owned by the user, “@alice” 140. Celly automatically parses time and date information and asks users to validate if they want an event and/or alarm associated with the event 142. When the alarm condition occurs, Celly sends the user an SMS reminder. A common usage of EigenChannels is for simple notetaking. Personal notes can be easily created by simply texting a message to a user's EigneChannel. For example, “@alice remember the milk and bread” would capture for Alice the note “remember the milk and bread”.

### Channel Namespace

In an SMS-based application cloud where messages must be less than 160 characters, namespace identifiers—channel names and user names—with fewer characters are desirable because they reduce keystrokes and preserve valuable character space for text messages. Identifiers with well-known meanings or popular associations are also desirable.

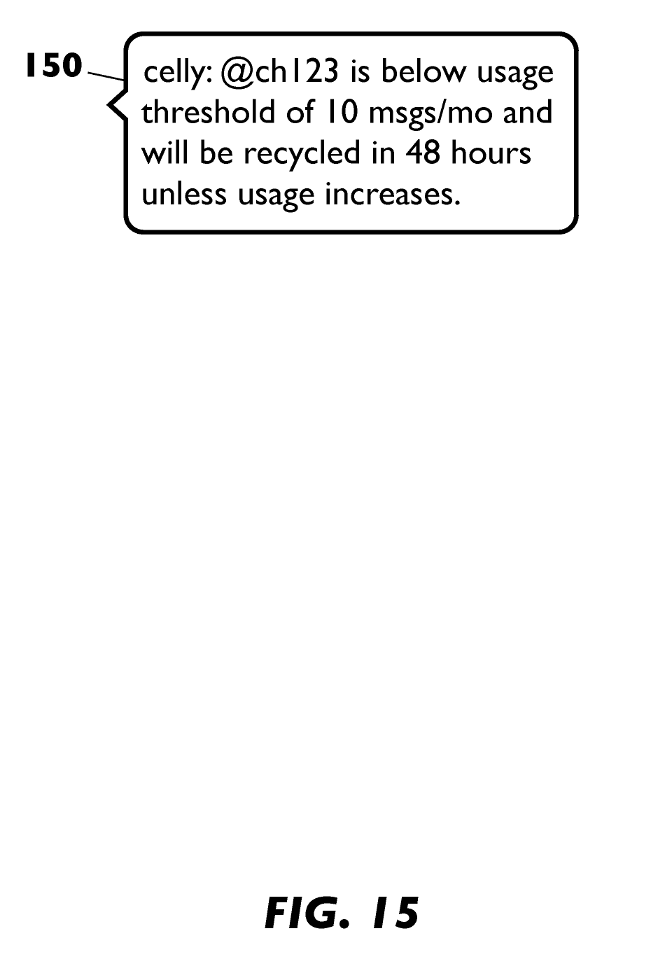

As a way to improve availability of namespace identifiers and discourage users from hoarding channel names, the present disclosure defines a novel method and system for managing namespace identifiers in an economy where infrequently utilized namespace identifiers are recycled and desirable names are bid upon. As shown in FIG. 15, when a channel falls below a predetermined usage criteria threshold—e.g., a certain number of messages sent per month, Celly sends the channel owner a text message saying that the channel will be recycled and made available as a new channel for another user unless the traffic level is maintained 150. If a predetermined amount of time elapses since the warning and the traffic level for the channel is not maintained, Celly returns the channel name to the available namespace pool and texts the channel owner saying that the channel has been recycled and gives the erstwhile channel owner the option to archive old channel messages. The predetermined time between warning and recycling is determined by the number of users waiting for the channel to become available. Once the channel name returns to the namespace pool, users can bid upon the name. The user with the highest bid retains the channel name for a predetermined length of time or until low usage triggers recycling.

### Search Engine

To help users discover and choose application services, the present disclosure creates a novel system and methods of aggregating, indexing, categorizing, and ranking text-based application services. These text-based services include not only Celly channels but also 3rd-party text-based services. In short, this embodiment creates a global search engine for SMS services.

Just as Web search engines spider the Internet analyzing Web pages, Celly's SMS search engine continuously trolls the Internet and the Common Short Code Directory (CSC Directory) for SMS-based services. For each SMS shortcode discovered, Celly captures SMS service information including shortcode phone number, name of the service, location details, and keyword topics associated with the service. For Celly channels, additional meta-information is collected such as channel followers, owner, ratings, usage statistics, hashtags, geotags, and pricetags.

TrackChannels that continuously query underlying search engine metrics help users triangulate and discover SMS services and Celly channels based on specific name, place, or tags. Users can rank and categorize 3rd-party text based service, adding metadata like keyword topics, location info, feedback and ratings. Users can see how many times a particular service has been looked up using the search engine and Celly utilizes search engine statistics to calculate leaderboard categories for channels and 3rd-party services such as “most popular SMS shortcode service” and “highest rated service within an area”. The search engine also provides a means for users to report SMS-based phishing schemes and spam. Hence the search engine provides a vital service of divining the quality of Internet-based text-based services.

### SMS User Interface Challenges

Text message size constraints, latency, and asynchronous delivery characteristics make it difficult to implement rich interactivity with SMS. Multi-user application design is further complicated by out-of-order delivery issues whereby multiple recipients may receive messages in different orders. Because input and output modalities are constrained by SMS to text-based messages in a command-line interface, application services that require a plurality of operating modes are also challenging to design. As the number of operating modes increases, users can become overwhelmed with navigating and memorizing a growing syntax of commands. Multitasking and disambiguating input and output intents and events targeted for independent application services is challenging with SMS, especially when compared to multi-modal graphical user interfaces. The present disclosure solves these design problems with a variety of novel systems and methods.

### MultiText

In this embodiment, users may create or subscribe to a plurality of channels. Given the variety of channel innovations implemented by the present disclosure, it is common for a Celly user to be members of tens or even hundreds of channels. The present disclosure implements novel, useful, and non-obvious methods by which multiple channels can be easily and effectively managed within a single underlying text-based messaging interface. These methods and system are known collectively as MultiText.

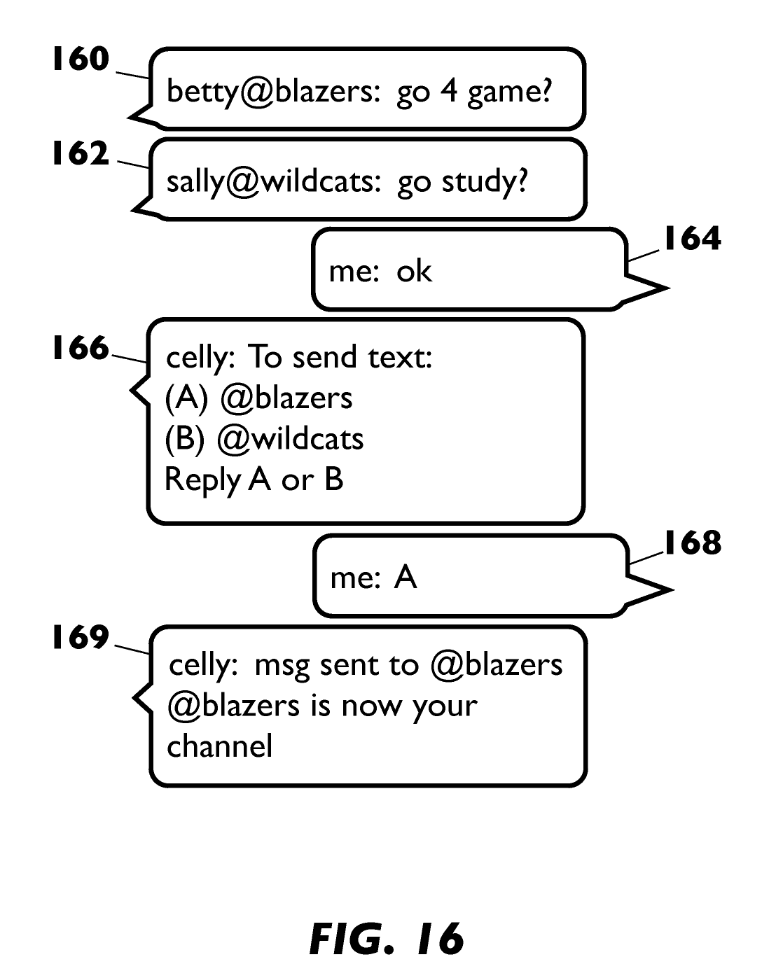

In this example embodiment, Celly multiplexes messages on behalf of all channels onto a single, underlying SMS shortcode. From a user's viewpoint, messages from all channels appear as conflated in a single message stream bound to Celly's shortcode phone number. As shown in FIG. 16, messages received by the user from different channels can become interleaved since all messages—no matter what channel they originate from—are received by the user's device as messages associated with Celly's single SMS shortcode.

Accordingly, a fundamental user interface design challenge is matching up and delivering user replies to their respective channel. For example, after consecutively sending a user messages from two or more independent channels, a user's subsequent reply must be carefully disambiguated by Celly to determine the user's intended channel destination.

To perform this disambiguation, as a key method and system of the present disclosure, Celly MultiText monitors channel message traffic to detect messaging interactions that potentially cause ambiguity. That is, in cases where consecutive messages from multiple channels are sent to the user, Celly keeps track of these channels in a queue and records the potential for ambiguity in subsequent user replies. Upon receiving a user reply while in a state of potential ambiguity, Celly responds by asking the user to choose the intended target from the list of queued channels. In this way, Celly matches up user responses with the intended channel and avoids sending a user's reply to the wrong channel.

To be clear, as shown in FIG. 16, when a user receives text messages consecutively from two or more channels, @blazers 160 and then @wildcats 162, Celly detects that a subsequent user reply 164 could be applicable to either of the previous two channel messages. To resolve this ambiguity, Celly explicitly asks the user for the target channel of the user's message 166. When the user sends a reply choosing a channel option 168, Celly then forwards the original user message on to the appropriate channel and sets the user's context to the channel 169. Subsequent user replies can then be sent by the user to the channel with no validation required (until message delivery from other channels again create ambiguity).

A non-obvious technique implemented by the present disclosure is the use of heuristic timeouts guided by pattern analysis of channel traffic. To determine conditions wherein user reply messages may result in ambiguous target channel destinations and hence require user clarification, Celly utilizes a “conversational timeout”. In cases where a user has not interacted with Celly for a default period of time—the conversational timeout—and then sends a channel message, the user's intended channel destination may be ambiguous if, for example, the user forgot the context of prior messages. In this case, Celly takes a conservative approach and assumes the channel destination of the message is ambiguous. Celly then resolves the ambiguity by asking the user to explicitly choose the intended channel destination from a list of the most recent channels the user has interacted with.

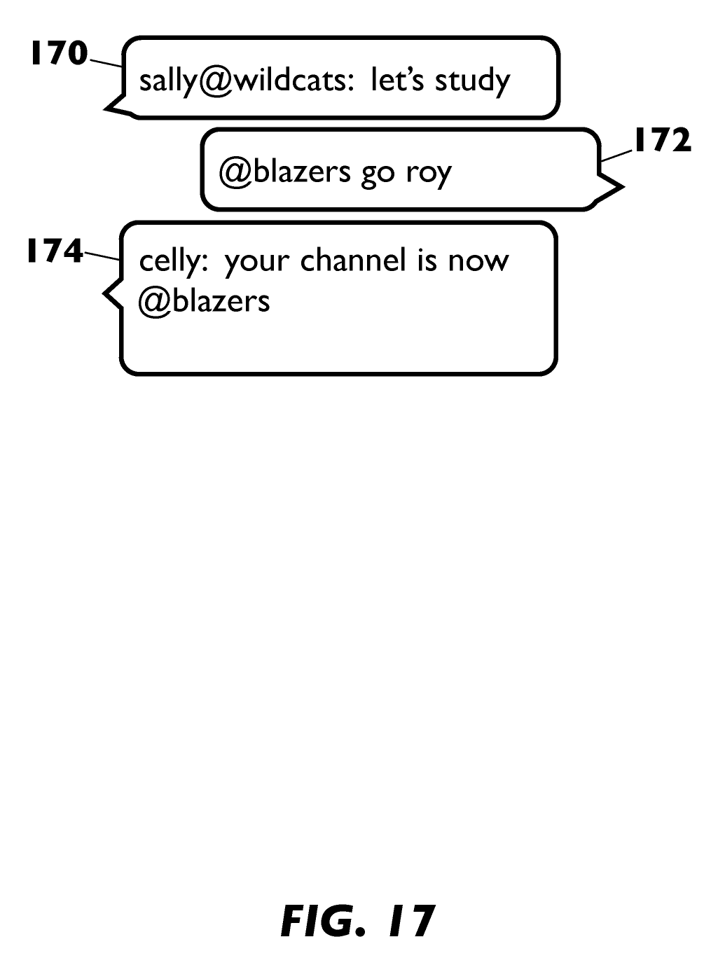

Celly defines a messaging syntax that lets experienced users send unambiguous messages by prefixing a reply with the name of the channel. As shown in FIG. 17, a user reply prefixed by the channel name, @blazers, 170 can be delivered directly to the named channel without the need for disambiguation. By sending a message prefixed by a named channel, the user's “current channel” becomes the named channel 174. Henceforth, the user can send messages on this named channel without prefixing the message with the channel name. This method provides a convenient shortcut that saves character space allowing users to pack more information into text messages, and when exchanging many, consecutive messages on the same channel, this method improves user experience by allowing replies to be sent faster and without channel name prefixing.

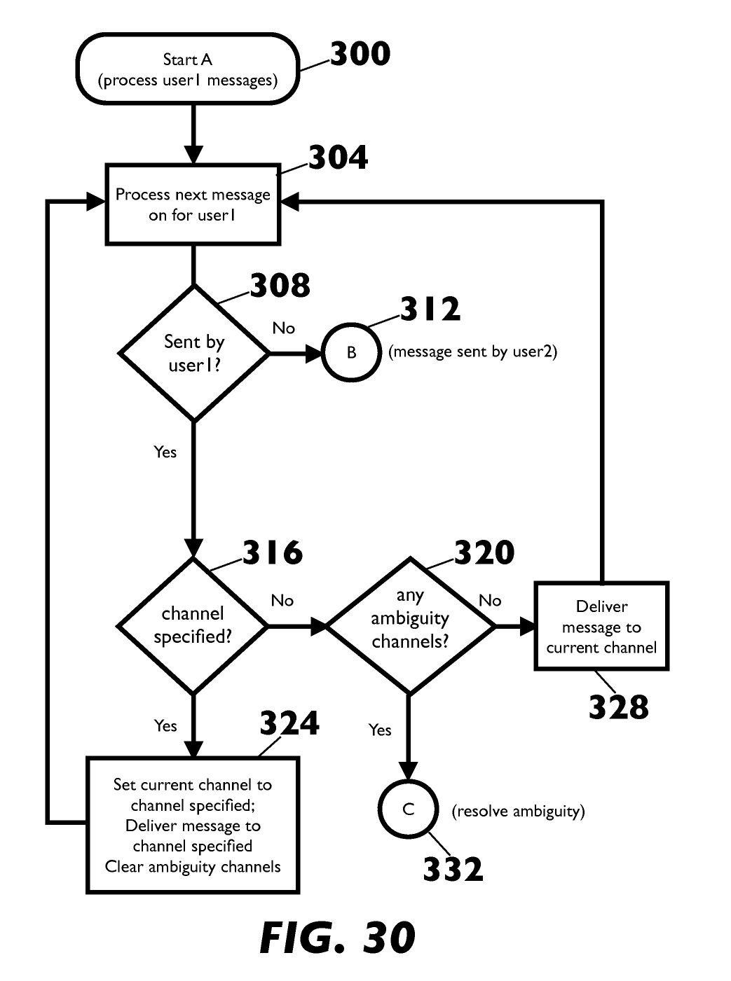

The flow process of MultiText is detailed in FIG. 30, 35, 38. comprising the steps of:

(a) checking if the user specified a current channel of interaction by explicitly sending a text-based message with the destination channel of the message specified 316;
(b) tracking changes to the user's current channel of interaction 324;
(c) receiving messages from a plurality of channels sent to the user via the single text-based messaging interface 300;
(d) tracking channels associated with messages received that are not associated with the user's current channel known herein as ambiguous channels 354;
(e) insuring a message sent by the user is delivered to its intended destination by monitoring a message sent by the user while ambiguous channels exist 320, sending the user a message containing the list of ambiguous channels via the text-based messaging interface 372, making a timed request for the user to reply with the channel destination 374, avoiding confusion for the user by queueing messages for subsequent delivery while the user is replying to the channel destination request 358, upon receiving the user's selected channel destination, delivering the message to the selected channel and clearing ambiguous channels 380, upon timeout, canceling the delivery of the message and clearing ambiguous channels 378.

The aforementioned system and methods known as MultiText enable a user to participate in many channels while maintaining privacy for the user by insuring that replies are matched up to the user's intended delivery channel. In addition to SMS, those skilled in the art will recognize any text-based messaging interface would also be suitable, including but not limited to VOIP longcodes, email, text terminals, programming shells, IM, IRC, and command-line shells. Furthermore, those skilled in the art will recognize that without MultiText, it would be cumbersome and error-prone to manually create a separate, physical underlying text-based messaging interface channel for each channel. Such a method would be undesirable as it would force users to manually keep track of each physical channel. For example, if each channel were backed by a ten-digit VOIP longcode, a user would have to create a contact label for each channel in order to associate it with a more memorable moniker. Such an activity would become cumbersome as the number of channels grew. Furthermore, as the channels timed out or were deleted, the user would have the burden to cleanup the stale contact.

### TextWizards

To create a rich user experience, text-based application services often need methods of displaying lists of information or engaging users in conversational-style interactions that help guide users through complex, operational sequences. The process of profile registration, e.g., often requires an application to collect multiple pieces of information from a new user such as name, grade, location, hobbies, etc. Compared to a graphical user interface where such information can be collected en masse via a single window-based form, collecting multi-faceted information via SMS is challenging due to the limited size of messages and inherent constraints of a command-line interface modality. Instead of a single user interaction, with SMS, multiple interactions are often required to collect or display many pieces of related information.

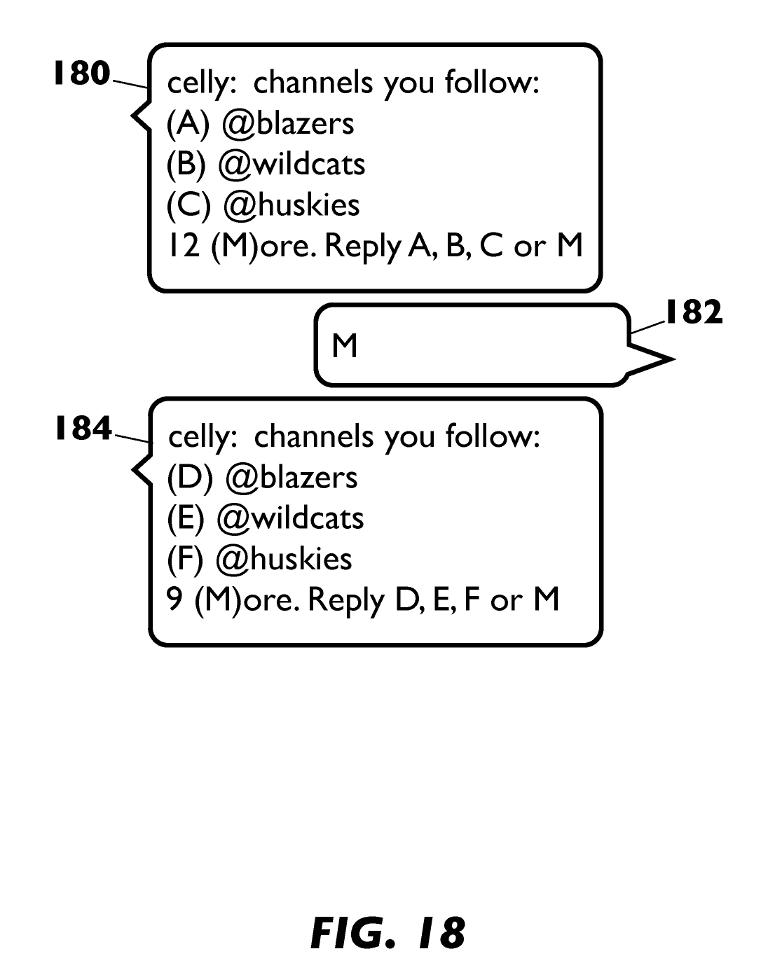

The present disclosure solves such challenges with “TextWizards”, a novel method that enables application services to convey detailed information (e.g. long result lists) and guide users through multi-step command sequences based on a series of text-based menus. Such methods obviate the need for users to memorize a plurality of commands since complex tasks or long list choices can be translated into “wizards” that guide a user in step-by-step interactions. As shown in FIG. 18, e.g., a TextWizard can display a list of reply menu options 180 where each option is enumerated by a shorter string of characters or a single character. The characters for each option are aggregated into a call-to-action reply line, “Reply A, B, C”. The number of reply options included in a text message is dynamically calculated by Celly based on available character space and the character lengths of each reply option. If there are more reply options than what can fit within the character space of the text message, a “(M)ore” option is added that in turn displays remaining menu choices on subsequent text messages 184. To indicate how many options are available, the number of remaining options is listed. Note, Celly deliberately combines the number of options to be displayed followed by “(M)ore” into a single phrase such as “12 (M)ore”. This compact expression—at most nine characters—efficiently conveys both the more option character “M” as well as connotes the number of remaining choices to be shown on subsequent messages. Users skilled in the art will appreciate the subtle efficiency and generic applicability of this syntactic form (with two digits reserved for displaying the number of choices, this syntax can indicate up to 99 choices).

A non-obvious, yet important aspect of TextWizards is the use of message delivery queueing to logically serialize channel interaction from a user's viewpoint. In other words, the present disclosure introduces a method of delaying the delivery of text messages from other channels while waiting a predetermined amount of time for the user to reply to a TextWizard. This method is useful because it permits the user to remain within the context of a current channel and complete a TextWizard interaction without becoming distracted or confused by messages arriving on behalf of other channels. Delivery queueing prevents interleaving of messages while the user is completing a TextWizard sequence. Those familiar with database theory will recognize and appreciate how this technique is similar to how a transaction manager enforces strong isolation and thus masks concurrent modifications to give applications a simplifed view of the world.

Furthermore, those skilled in the art will recognize that a single response to one TextWizard can trigger the invocation of another TextWizard enabling dynamic, navigational sequences for such applications as multi-question surveys, text-based role-playing games, and interactive text bulletin boards where user responses can drill down into hierarchically structured content and discussion areas.

### Abbreviation and Aliases

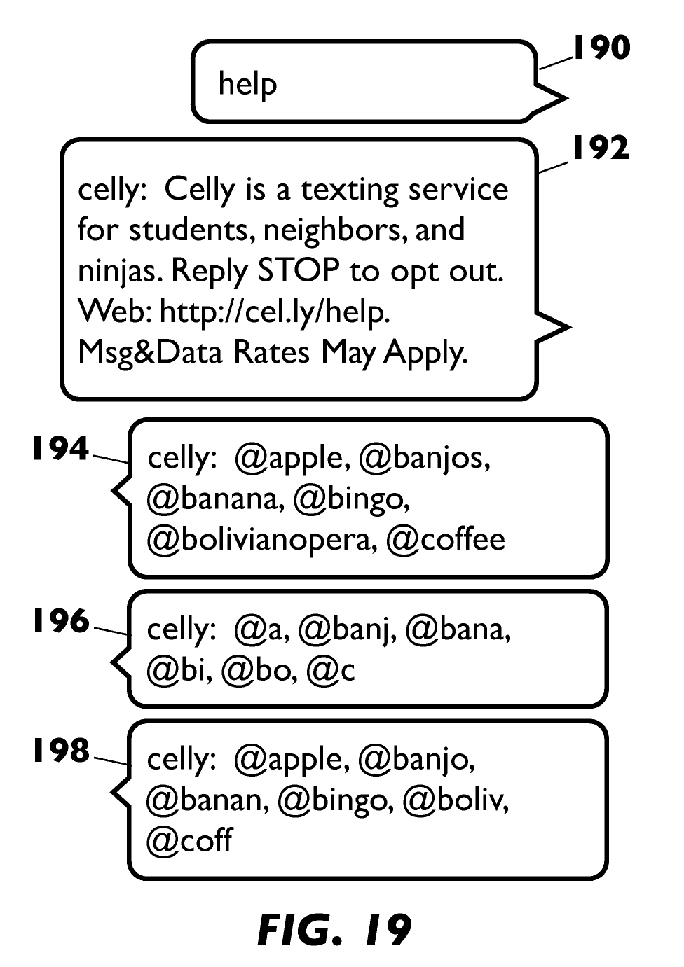

For SMS-based application services each message can be at most 160 characters. This limited character economy per message is further restricted by the need to dedicate character space in some text messages for phone carrier mandated copy. As shown in FIG. 19, as prescribed by Mobile Marketing Association best practices, the HELP command 190 requires inclusion of the phrase “Msg&Data Rates May Apply” as well as the Web service URL “http://cel.ly/help” and opt-out instructions “Reply STOP to opt out” 192. Hence, for a HELP message, more than 60 characters are consumed by mandated copy leaving less than 100 characters for a service-defined message. For monetization purposes, character space may be further limited because of dedicated ad space. In Celly, this character space is typically 20 characters leaving only 140 characters for system generated messages. To make the most of this 140 character space, the present disclosure implements novel methods for abbreviating and aliasing identifiers.

As core service for text-based applications, to maximize message content, Celly dynamically abbreviates identifiers like channel names when displaying system generated messages. Abbreviations are customized according to a user's symbol space and dynamically adjusted according to the available character space in a message. For example, to deliver a message with a long list of channels 194 named @apple, @banjos, @banana, @bingo, @bolivianopera, and @coffee, to preserve character space Celly may abbreviate these channels as @a, @banj, @bana, @bi, @bo, and @c respectively 196. In cases where a message has more available character space, to improve legibility, Celly extends the number of characters for each abbreviated channel name: @appl, @banjo, @banan, @bingo, @boliv, @coff 198. The key is that Celly automatically shrinks or expands the number of characters per identifier based on available space. In messages with ample character space, Celly does not abbreviate identifiers. In messages with very limited character space—due to the fact that the message contains a lot of non-identifier copy—Celly abbreviates aggressively. Abbreviations are always unique within a user's symbol space—all channel and user name identifiers visible to a user. As a simple method of generating unique abbreviations, Celly incrementally builds up a prefix by enumerating the characters in an identifier from left to right and at each step checks to see if there are other identifiers that matches the prefix. If not, then the prefix is compared to a predetermined list of reserved identifiers, aliases, and offensive phrases; if there is no match, then the prefix becomes the abbreviation. More sophisticated algorithms for generating unique abbreviations may be utilized, e.g., algorithms that preserve beginning and ending characters of the identifier or algorithms that truncate at syllable boundaries. In any case, Celly can generate an abbreviated form of an identifier to reduce space and so allow more words to be included in a message.

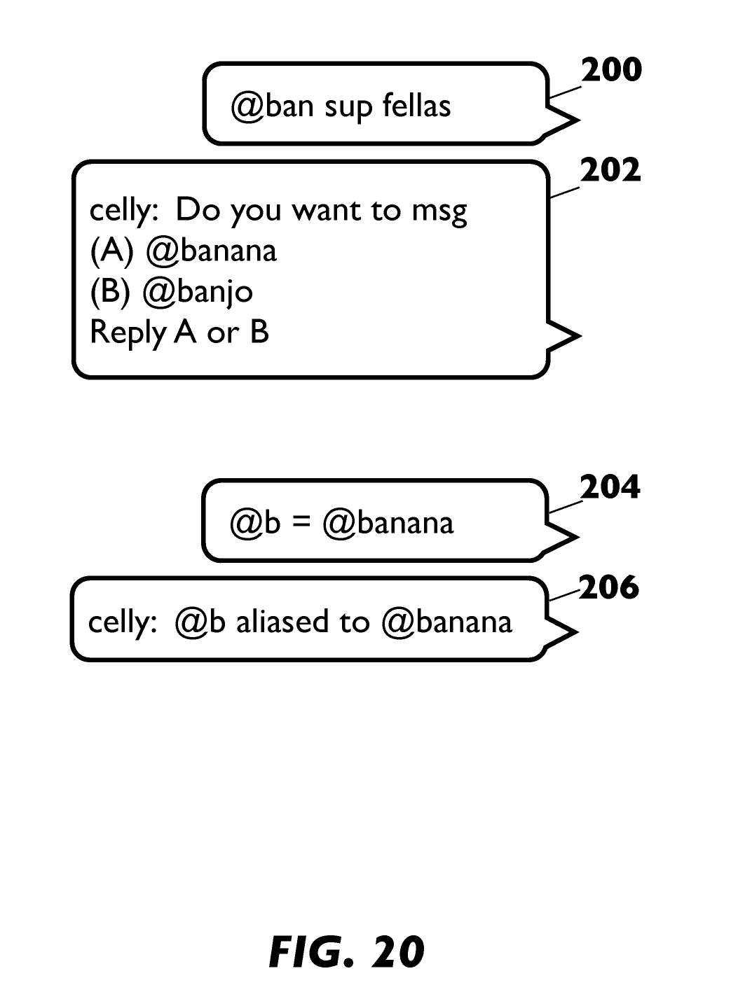

On receipt of a user message, Celly parses channel name identifiers and canonicalizes any user abbreviations to the full channel name. This technique enables a user to conveniently shorten the number of characters in a channel name and thus save time and space when sending messages to Celly. As shown in FIG. 20, in some cases, the user may provide an ambiguous channel abbreviation, e.g., a channel abbreviation @ban 200 would be ambiguous if it could match both @banana or @banjo. In this case, Celly asks the user to resolve the ambiguity 202. The disambiguation process also considers queued channels recorded by MultiText. That is, in cases where consecutive messages from multiple channels are sent to the user, Celly attempts to first match user abbreviations according to the queued channel name identifiers. If a match is not found, then the user's other channels are matched.

As another novel method of preserving character space, Celly lets users define aliases for identifiers like channel names. For example, a user can define a shorthand alias like @b for the channel named @banana 204. In this way, users can dramatically reduce the number of characters used when identifying a channel. Celly maintains a map of user-defined aliases and matches them up with fully-qualified channel and user names.

### Functional Modes

Text-based messaging user interfaces like SMS restrict user interaction to just a single input and output modality known as a command-line interface (CLI). As a mechanism for interacting with hosted application services by inputting text-based commands to perform specific tasks, a CLI is a text-only interface that commonly resorts to the use of “modes”. A mode is a distinct method of operation within an application service, in which the same input can produce different perceived results depending of the state of the application service. Overuse of modes, however, can decrease usability, as a user is encumbered to remember current mode states and toggle between a plurality of modes as necessary.

Accordingly, the present disclosure introduces a novel method of organizing all cloud-based service interactions into a handful of functional modes. These functional modes—known figuratively as “Knock”, “Slash”, “Bang”, and “Boomerang”—enable conversational, declarative, imperative, and programmatic modes of interaction respectively.

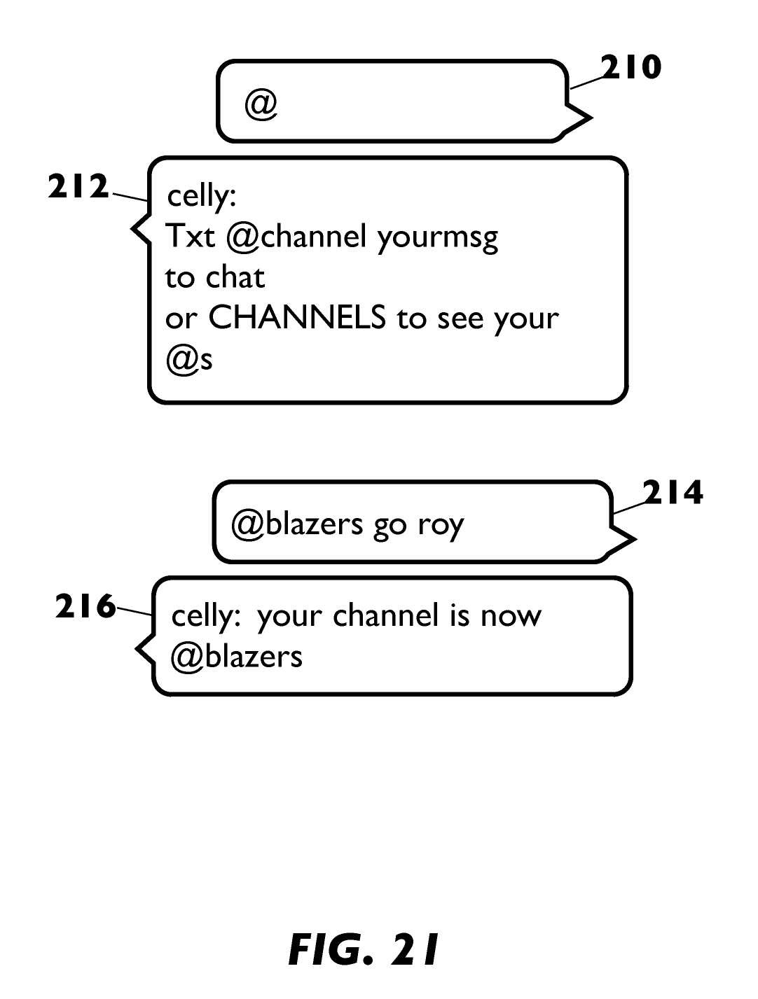

As shown in FIG. 21, a user enters conversational mode by texting a single “@” 210. From an imagery viewpoint, “@” can be thought of as a knocking gavel or mallet that enables users to initiate and bring to order conversation by selecting a particular channel. Having selected a channel, subsequent text messages can be entered without a prepended channel name. If messages from another channel are sent to the user while the user is in an existing channel conversation, the MultiText protocol defined above is applied, disambiguating subsequent text message replies to prevent the user from inadvertently sending a reply to the wrong channel. The user may deliberately switch conversational focus to a different channel by starting a text message with any channel name 214.

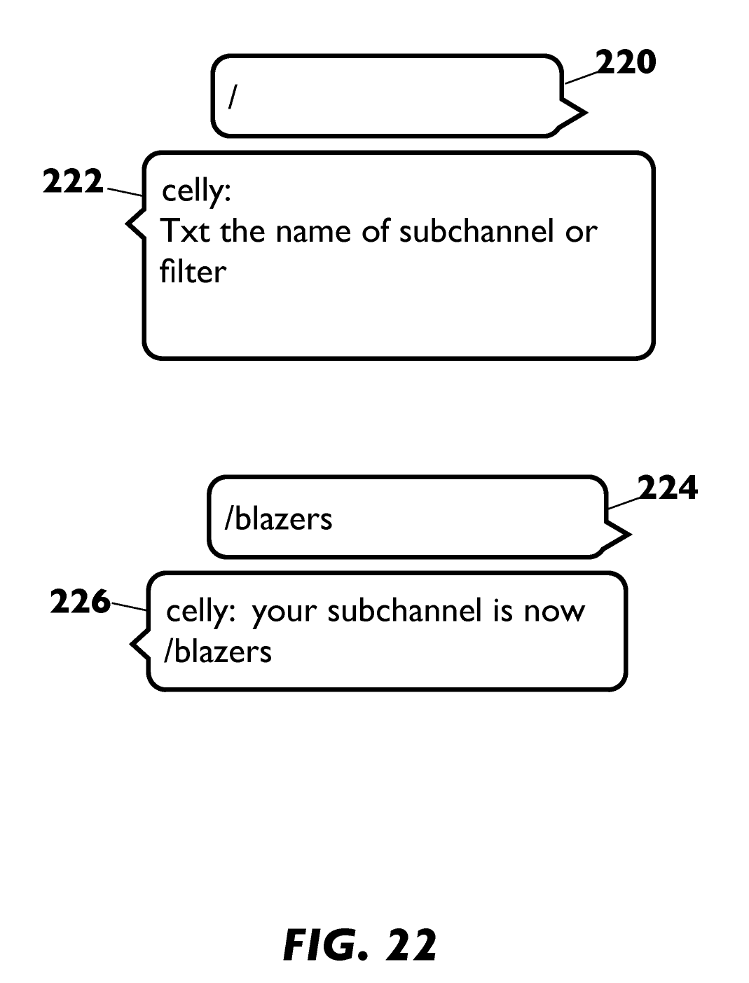

As shown in FIG. 22, a user enters declarative mode by texting a message with a slashtag or a single “/” 220. From an imagery viewpoint, “/” can be thought of as a sword or knife that enables users to declaratively narrow down what they are looking for by “slashing” or filtering. In other words, a slashtag initiates a declarative Web search or, if initiated within the context of a current channel, acts as a channel filter. Hence, declaring a channel filter slices a channel creating subchannel partitions where messages related to the topic of the filter are aggregated and conversational messages can be localized. In other words, declaring a channel filter can create topic areas or bulletin boards within a channel.

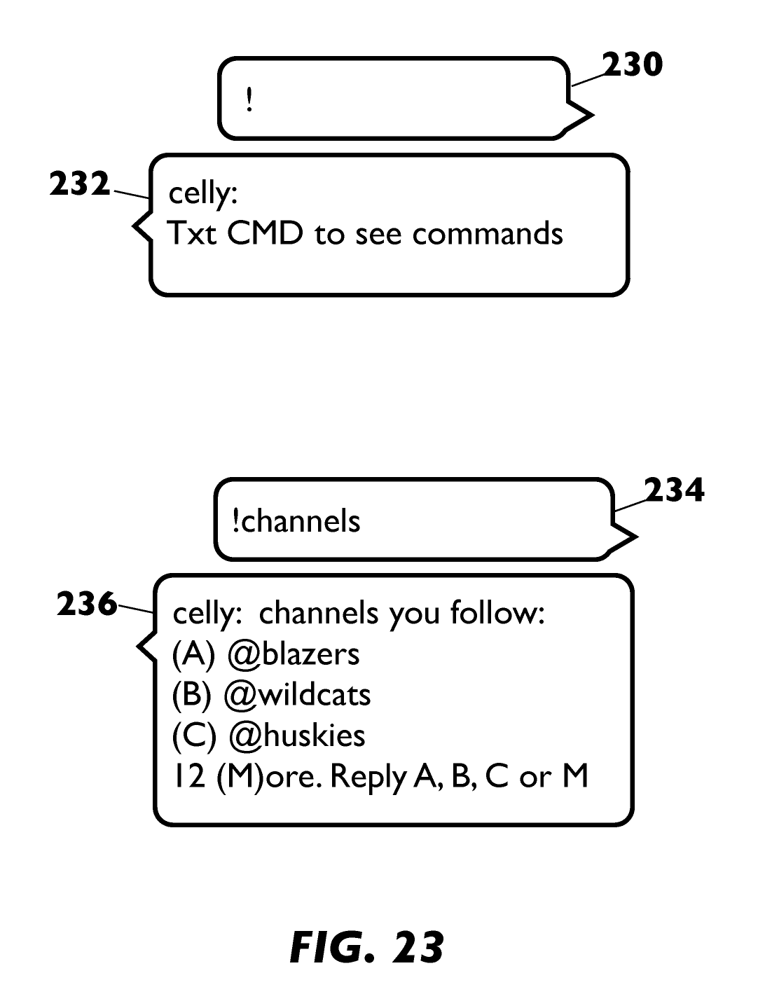

As shown in FIG. 23, a user enters imperative mode by texting a message with a “bangtag”, a command name prefixed by a “!”. From an imagery viewpoint, the bang symbol “!” 230 can be thought of as “triggering” a command. In Celly, bangtags can be used for a variety of tasks such as channel, member, and user profile management. For example, !channels 234 shows the list of channels a user follows. Application services can define bangtags for their own purposes. In Celly, a functional equivalent name for bangtags are “tasktags”.

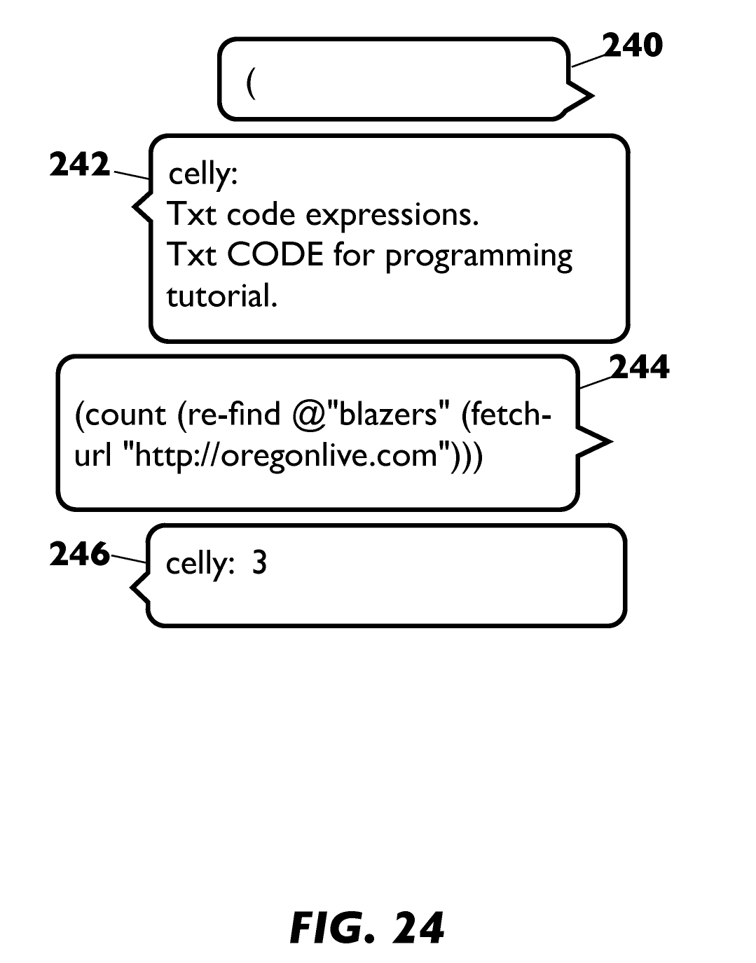

As shown in FIG. 24, a user enters programmatic mode by texting a message starting with a “(” 240. From an imagery viewpoint, “(” symbolizes a “boomerang”, that is, a tool that gives skilled users, a.k.a “ninjas”, complete full-circle control over their Celly environment by providing a powerful Read Evaluate Print Loop (REPL). In this embodiment, Celly transforms the SMS command-line into a novel programming language REPL known as NinjaText. NinjaText is a LISP (based on Clojure) so has minimal primitives and syntactic forms and can be easily extended for domain-specific applications via macros. In NinjaText namespaces and identifiers can be created for both private and public usage. Users can define and share channels by deriving them from existing channel identifiers and filtering them with hashtags, geotags, and pricetag operators, e.g., “(@justBlazerNews (@blazers #97202))” creates a new channel @justBlazerNews based on a geotag filtered @blazers channel. Because NinjaText is a Turing complete programming language with full Java library support, advanced Celly users can define and share arbitrarily complex functions and data. NinjaText programs can connect Celly to any information resource like Web sites. By exploiting the rich, built-in networking library, it is easy for a user to define functions like “fetch-url” that can be used to extract Web content from any URL:

(defn fetch-url[address]

(with-open [stream (.openStream (java.net.URL. address))]

(let [buf (java.io.BufferedReader.

(java.io.InputStreamReader. stream))]

(apply str (line-seq buf)))))

Aggregation and searching of Web content with regular expressions can in turn be easily applied to “fetch-url” results, returning a count of keyword terms in a Web site 244:

(count (re-find @“blazers” (fetch-url “http://oregonlive.com”)))

NinjaText is a homoiconic language where code and data are equivalent. Hence functions can be named and shared and applied to any channel. Channels names are prefixed with a predetermined symbol, e.g. “@”, and are made “seq-able”: channels can be interpreted and processed as sequences using convenient LISP programming libraries built-in to NinjaText. All syntactic forms and identifiers defined in Pound, Slash, and Bang modes are compatible with NinjaText. NinjaText, therefore, transcends the other functional modes, creating a useful, novel, and non-obvious method and system for extending the Celly cloud via a native programming language.

### Application Programming Interface

In addition to the NinjaText programming language, Celly also implements an Application Programming Interface (API) to enable third-party developers to extend the core text-based messaging cloud with custom applications. The Celly API provides access and management for cloud resources including, but not limited to, users, channels, game mechanics, and statistics. APIs are REST services. Developer applications are made available on the Celly cloud in an application store.

### Mobile Phone Application

From an architectural viewpoint, to create a rich and scalable text-based messaging application cloud, the present disclosure takes unique advantage of mobile phones, e.g., smartphones, that are capable of running customized applications. Users skilled in the art will recognize that other communication and storage devices capable of executing a computer program, including but not limited to, game consoles, televisions, sensors, mobile, tablet, and desktop computers could similarly be utilized by the present disclosure.

Unified SMS inbox

As one of only two communication services embedded on all mobile phones (the other is voice), SMS provides a basic means to communicate between mobile devices in a device-agnostic manner. To expand this basic SMS functionality, mobile phone software development kits (SDKs) provide APIs that give customized applications full access to core SMS functions. Mobile phone applications, e.g., can send and receive SMS messages, access a user's contact list (often stored in an address book application), and even intercept and interpret all SMS communication traffic on behalf of a user, regardless of what contacts or shortcode services individual SMS messages are sent to or received from. Accordingly, the present disclosure implements a mobile application that not only manages Celly channels, but also manages non-Celly SMS messages. In other words, Celly's mobile application creates a unified “SMS inbox” that captures all text messages on behalf of a user.

Improved security through prevention of cyberbullying, spam, and phishing Celly's SMS inbox enables whitelisting/blacklisting for SMS traffic received by a user's mobile device. In this way, the user can turn on or off incoming SMS messages from any person or service. In addition to whitelisting/blacklisting, the SMS inbox permits the user to filter, prioritize, block, rank, and comment on senders as well as SMS shortcode services.

With permission from users, a user's feedback is aggregated and shared across Celly members to provide “wisdom of the crowd” collective intelligence, improving profile reach and accuracy, and thus creating a novel, useful, and non-obvious collaborative prioritization and filtering method and system for preventing cyberbullying, spam, and phishing. Users may view a “social report card” for a shortcode service or individual in order to decide whether to permit or block a particular service or user. Social report cards are also accessible from global search engine queries.

### Suggestions and Interest Graph Analytics

The mobile application of the present disclosure performs analysis of user SMS communication patterns (with user's permission) to identify and suggest potential contacts each user might want to invite to private channels or to identify shortcode services a user might find useful or interesting.

By collecting voluntary SMS traffic usage patterns across members, Celly divines SMS analytics into an “Interest Graph”. The Interest Graph captures links between users and channels of interest. For a user in Portland, Oreg. following the @blazers channel, Celly, e.g., might suggest a related channel of interest like @portlandhighschoolbasketball based on the fact that other users in Portland, Oreg. who follow @blazers also follow @portlandhighschoolbasketball. To build interest links between channels, Celly analyzes channel subscription patterns according to users, metadata such as hashtags and geotags, and message content—words and phrases appearing within individual text messages. With collective insight to opt-in personal and group-based SMS conversations combined with Interest Graph analytics, the present disclosure creates a realtime advertising network where ad placement is targeted to channels with related topics and to users who send and receive messages containing words relevant to the advertiser's campaign.

### Ambient Cloud

Beyond basic, connectionless SMS communication, mobile phone applications are also capable of advanced, connection-oriented communication with the cloud—e.g, via TCP sockets—and can thus stream information on-demand to and from the mobile device and the cloud. Mobile applications can furthermore execute programs that offload computational functions and cache data on behalf of cloud infrastructure.

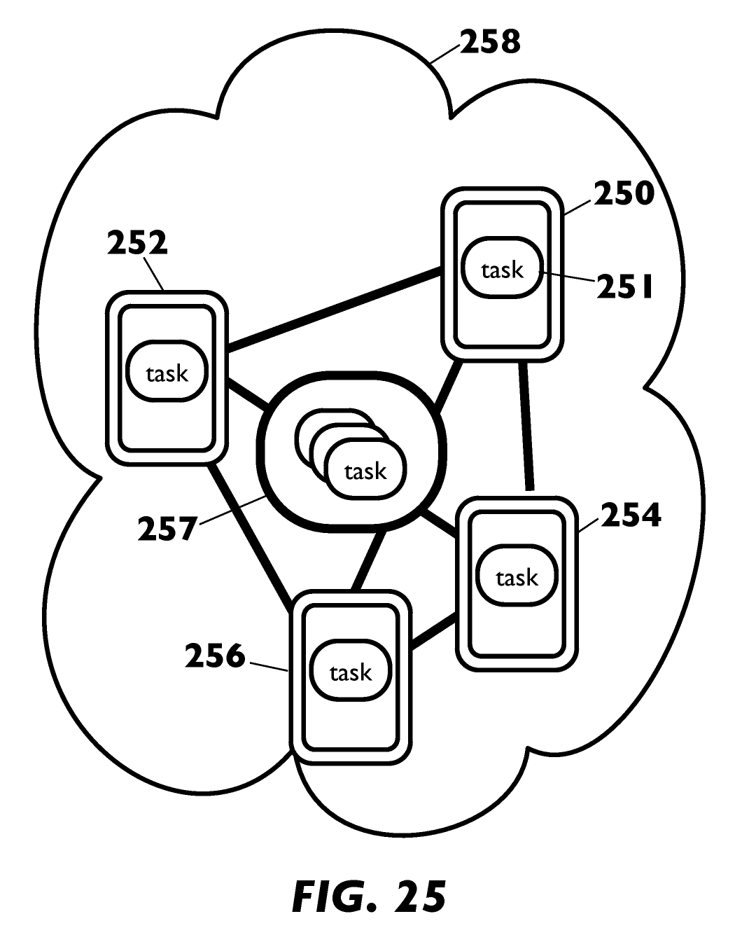

Accordingly, this embodiment of the present disclosure creates novel system and methods that leverage the advanced networking, storage, and processing utility of mobile phone applications. Specifically, as shown in FIG. 25, Celly's edge application transforms remote devices like user smartphones 250 252 254 256 from passive clients to active peer-to-peer “servers” that are in turn networked together logically into an “Ambient Cloud” 258 coordinated by a hosted service 257 that sends tasks 251 and receives task results from edge devices.

In contrast to prior art monolithic search engine architectures—e.g., Google builds centralized, multi-billion dollar data centers that require enormous amounts of power and many networked computers and storage systems—Celly's approach to cloud scalability harnesses the collective power, CPU, network, and storage of many decentralized edge devices working together. From a resource viewpoint, Celly offloads file storage, Web service requests, networking, and computational tasks like indexing to an application running on remote edge devices. Celly's Ambient Cloud application is resource-aware and schedules requests according to user-defined timelines and thresholds including power availability, e.g., Celly tasks might activate at night when a remote device is “plugged-in” and user CPU activity is low. Celly gives users the ability to control who ambient processing is for and how much bandwidth is used. For example, a mobile application user may only enable ambient processing on behalf of users that share the same geolocation, interests, or social group.

By federating user edge devices into a decentralized mobile cloud, Celly scales service growth while minimizing, or potentially obviating altogether, the need for traditional dedicated servers provisioned at IT data centers. As more users join and run Celly's Ambient Cloud application, more power, compute, networking, and storage resources become available for Celly's text-based messaging application services cloud. As the Ambient Cloud grows, Celly can monetize its Ambient Cloud infrastructure, offering free and fee-based cloud computing services outright including storage and compute job scheduling ala SETI@home and Folding@home projects.

### Scalable Track

A key advantage of the Ambient Cloud in the present disclosure is that it enables scalable processing of TrackChannels. As introduced previously, TrackChannels are derived from continuous queries on underlying data stream resource—e.g., SMS Channels, Web feeds, and sensor nets—that are filtered for items of interest such as social presence data, news, items for sale, coupons, pricing conditions, and location-based events. To process a TrackChannel, Celly frequently polls the underlying stream resource and applies filtering criteria according to user-defined hashtags. When a match occurs, Celly pushes the matching data to TrackChannel subscribers as text-based alerts. In cases where multiple TrackChannel definitions have similar query predicate overlap, i.e., the underlying stream resource—e.g., a Web site feed—is the same in multiple TrackChannel definitions and corresponding hashtags share common values or prefixes, Celly performs multi-query optimizations through the use of predicate indexes. A predicate index is a tree structure that organizes predicates taken from all TrackChannels with the same underlying stream resource into a tree. In cases where predicates are text based hashtags, Celly organizes hashtags into a trie structure, a.k.a. a prefix tree. For numerical predicates like pricetags, Celly organizes such tags into a range-based tree structure (e.g., a subclass of a red-black tree). For geotag predicates, Celly first translates geotags into geocodes and then builds location-specific indexes where geotag relationship hierarchies are captured. Specifically, when one geotag encompasses the range of another geotag, a parent-child relationship is stored. The aggregation of such relationships creates a containment tree index whereby a predicate match to a node within this tree can efficiently identify the ordered range of other matching predicates. For example, for a match to the geotag of “97202”, the containment tree index can efficiently match subsuming geotags of “Portland” and “Oregon”.

Users skilled in the art will recognize the computational, power, networking, and storage challenges of processing a plurality of TrackChannels: first, a single update to an underlying stream resource may match an unbounded number of predicates; second, the power, network bandwidth, and storage required to continuously poll underlying stream resources grows with the number of unique underlying stream resources associated with TrackChannels; third, querying underlying stream resources is subject to rate-limiting since target Web sites must prevent a single requestor from over-utilizing the resource.

To address the aforementioned challenges, Celly implements a novel method and system for TrackChannel management based on the Ambient Cloud. Celly utilizes mobile phone applications to invoke and cache Web service requests on behalf of user opt-in TrackChannel queries. The Celly cloud thus offloads TrackChannel processing to mobile edge servers, enabling massive scalability while reducing centralized server load. By enlisting the use of mobile phone devices, each with their own separate IP address, Celly avoids the need for rate-limiting since Web requests are invoked from a plurality of IP addresses rather than a few centralized servers. Celly leverages the power and network resources of individual mobile devices to provide caching and sharing of previous query results. Index maintenance and analytic processing are similarly offloaded to mobile phone applications.

In contrast to prior art search engine techniques that depend on expensive Web crawlers, spidering outward from a centralized host service, Celly's novel architecture obviates the need for crawling, replacing it with an event-driven process whereby each mobile app performs local TrackChannel queries and automatically pushes query results inward to the Celly cloud. This event driven approach not only saves bandwidth, compute, storage, and power by avoiding costly server-based polling, but this approach minimizes latency of TrackChannel processing resulting in realtime TrackChannel updates. In this way, Celly enables scalable and realtime processing for opt-in TrackChannels.

### Mobile Ad-hoc Networks (MANET)

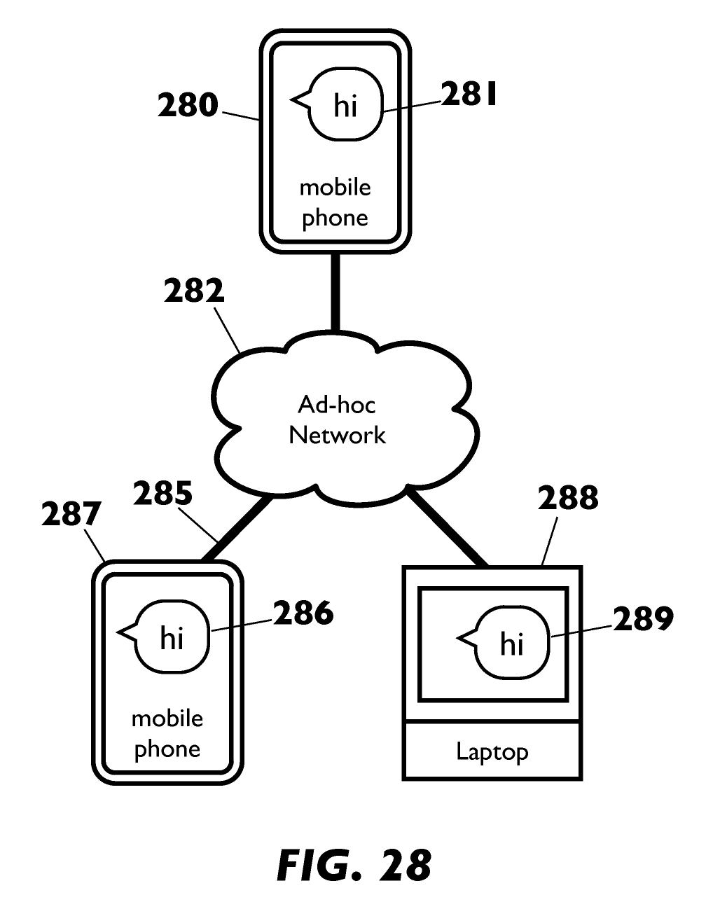

Celly's mobile phone application creates a novel method and system for highly available group communication services. As illustrated in FIG. 28, the present disclosure utilizes ad-hoc networking capabilites built into smartphones to create mobile ad-hoc networks 282 (a.k.a MANETs) for group communication 281, 286, 289. For example, in places where IP communication is disrupted, e.g., due to natural disasters or government intermediation, Celly's mobile phone application utilizes the most advantageous means for communication—including but not limited to wired landline, built-in WIFI, Near Field Communication (NFC), GPS, and/or Bluetooth—to assemble an ad-hoc peer-to-peer 280, 287, 288 network 282 whereby text messages can be routed to and from any device—mobile or otherwise 289—in the ad-hoc network. As communication degrades, Celly's mobile application gracefully degrades opportunistically, by default utilizing the best available communication channel in terms of bandwidth and latency. In cases where message delivery is interrupted altogether due to network segmentation, e.g., because a relaying device is turned off or leaves the communication range of other devices, en-route messages are stored in at least one device in the routing pathway and then forwarded on when connectivity is restored.

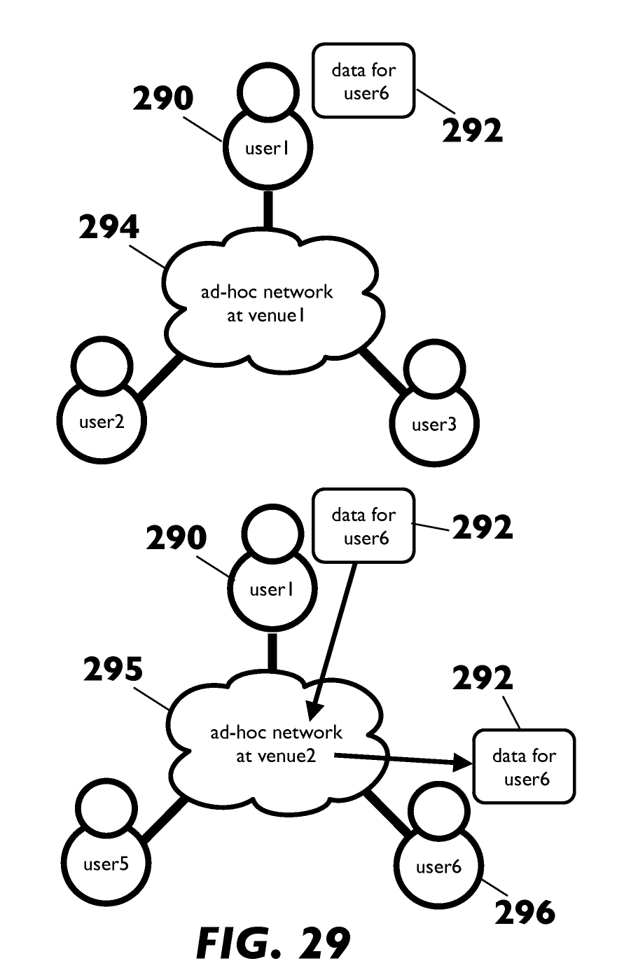

Celly's message routing approach to mobile ad-hoc networking is non-obvious as it leverages novel insight into how individuals aggregate during times of crises. During disruptive communication outages, individuals tend to herd together into public meeting places. Hence the proximity of one user with a smartphone to another user increases in such public venues. As more smartphone users aggregate to the same geographic area, the size of the MANET grows and hence the ability for routing group communication messages grows. As shown in FIG. 29 diffusion of messages from one MANET 294 to another then occurs as an individual 290 physically moves from one venue to another venue where people are gathering. Once connected in a new MANET 295, messages 292 stored up from the old MANET 294 can be delivered. Through this process of message queuing and physical movement of users with mobile smartphones, messages are effectively routed and eventually delivered to endpoint destinations 296.

Note, beyond optimizing text-based group communication, in cases where voice or data communication is desired, Celly's underlying text-based communication service can be encoded to deliver and assemble voice or data packets. In this way, voice or data communication can also be sent and received using Celly's MANET.

Fundamentally, Celly's mobile application creates a physical, underlying communication channel on top of which Celly's basic multi-user channels can be created and managed to facilitate group communication. Celly MANETs can be utilized in a plurality of scenarios including, but not limited to, disaster relief, remote areas without cellular networking capabilities including vacation/tourist locations, areas with limited or no cellular networking capabilities such as roadways or enclosures such as subways or trains.

Furthermore, by virtue of the fact that Celly MANETs utilize available networks such as WIFI networks, connectivity from one Celly MANETs to another Celly MANET and to global communication networks including the Internet are enabled. Thus communication between any two endpoints, where each endpoint may be in any of these networks, is possible. Thus the invention enables connectivity between heretofore isolated networks. This enables more information to flow to and from locations where prior-art networking methods are disabled by disaster, wars, etc.

What is claimed:

1. A text-based messaging application cloud comprising:
(a) computer processor means for processing data;
(b) storage means for storing data on a storage medium;
(c) network means for exchanging data between said computer processor and a plurality of communication devices, each communication device comprising a memory and transceiver, the transceiver operating according to a text-based messaging interface;
(d) first means for processing data regarding creating a username identity by receiving a text-based command from a communication device via said text-based messaging interface;
(e) second means for processing data regarding creating a text-based messaging channel for group communication by receiving a text-based command from a communication device via said text-based messaging interface;
(f) third means for processing data regarding managing the administration of channel privacy modes and channel membership by receiving text-based commands from a member's communication device via the text-based messaging interface;
(g) fourth means for processing data regarding exchanging messages between members of a channel by receiving a text-based command from a first user's communication device via the text-based messaging interface, accessing members of a group from the storage medium, sending each of these members the first user's message via said text-based messaging interface;
(h) sixth means for processing data regarding exchanging text-based messages using the text-based messaging interface without revealing device identifier information by displaying message sender information as user names rather than device identifiers;
(i) seventh means for processing data regarding addressing and displaying channels according to unique channel names shared in a system-wide namespace.
(j) eight means for processing data regarding managing a user's concurrent subscriptions to a plurality of channels, enabling the user to simultaneously participate in a plurality of application services utilizing a single text-based messaging interface.

2. The system of claim 1, further comprising a method of chaining text-based message sequences via the text-based messaging interface enabling rich, interactive text-based messaging channel applications that obviate the need for a user to memorize a plurality of text-based messaging commands and overcome the limited message size of text-based messaging interfaces by breaking complex tasks or long list choices into guided, multi-step interaction sequences, comprising the steps of:
(a) sending a first text-based message menu on behalf of a current channel to the user containing a plurality of menu options via the text-based messaging interface, each menu option being associated with a shorter string of characters to be recited in the user's reply, wherein the number of reply options included in the menu is dynamically calculated based on available character space of the text-based messaging interface and the character lengths of each reply option;
(b) adding an option in the reply as needed that will return a text-based message that displays remaining menu choices if there are more reply options than what can fit within the character space of the text message;
(c) adding a count as needed showing how many more menu options are available beyond the options already displayed to the user;
(d) receiving the user's reply to the first text-based menu and based on the chosen reply, optionally replying to the user via the text-based messaging interface with a subsequent text-based messaging menu request or response;
(e) delaying message delivery from other text-based channels while a user is interacting with a menu for the current channel.

3. The system of claim 1, further comprising a method of filtering text-based messages arriving on one or more channels, and automatically routing matching messages to derivative channels linking a plurality of channels into a network, comprising the steps of:
(a) defining a combination of one or more hashtag or keyword filters, a plurality of source channels to be filtered, and a derivative channel to receive text-based messages that match the filter;
(b) continuously filtering the source channel for text-based messages containing said hashtags or keywords;
(c) sending matching text-based messages to the derivative channel via the text-based messaging interface; continuously emitting prospective search results regarding future conditions, events, and data based on topics of interests.

4. The method of claim 3, further comprising filtering based on semantic type specifications parsed from hashtags including:
(a) location information including geo-converted zipcodes;
(b) date and times
(c) pricing range specifications;
(d) regular expressions;
(e) multiple word phrases, where phrases are surrounded by hashtags.

5. A system of group collaboration implemented for a plurality of text-based channels enabling users to coordinate workflow tasks using text-based messaging, comprising:
(a) computer processor means for processing data;
(b) storage means for storing data on a storage medium;
(c) network means for exchanging data via text-based channels between said computer processor and a plurality of communication devices, each communication device comprising a memory and transceiver, the transceiver operating according to a text-based messaging interface;
(d) first means for processing data regarding monitoring when a first user posts a task by sending a text-based message to a channel that includes a predetermined task symbol prefixing a keyword;
(e) second means for processing data regarding parsing the first user's keyword, generating a globally unique sequence identifier for that keyword, concatenating a string consisting of the predetermined task symbol, keyword, and the unique sequence identifier; substituting this string into the original message; broadcasting the message to the channel;
(f) third means for processing data regarding monitoring when a channel message containing a predetermined task symbol suffixing the keyword is posted to the channel indicating that a task is closed;
(g) fourth means for processing data regarding sending a message to the channel announcing that the task is closed.

6. A method of multiplexing a plurality of text-based channels on behalf of a user utilizing a single text-based messaging interface enabling the user to interact concurrently with a plurality of text-based channels, comprising the steps of:
(a) enabling the user to specify a current channel of interaction by explicitly sending a text-based message with the destination channel of the message specified;
(b) tracking changes to the user's current channel of interaction;
(c) receiving messages from a plurality of channels sent to the user via the single text-based messaging interface;
(d) tracking channels associated with messages received that are not associated with the user's current channel known herein as ambiguous channels;
(e) insuring a message sent by the user is delivered to its intended destination by monitoring a message sent by the user while ambiguous channels exist, sending the user a message containing the list of ambiguous channels via the text-based messaging interface, making a timed request for the user to reply with the channel destination, avoiding confusion for the user by queueing messages for subsequent delivery while the user is replying to the channel destination request, upon receiving the user's selected channel destination, delivering the message to the selected channel and clearing ambiguous channels, upon timeout, canceling the delivery of the message and clearing ambiguous channels.

7. A system harnessing the collective power, CPU, network, and storage of many decentralized mobile communication devices working together as a client computing cloud, comprising:
(a) network means for exchanging, coordinating, and executing tasks on a plurality of mobile communication devices coordinated by a centralized hosted service, each mobile communication device comprising a computer processor, memory, transceiver, and a computer program that executes the logic for task execution, comprising:
(b) first means for processing data regarding utilizing device resources for task work according to user-specified schedules;
(c) second means for processing data regrading utilizing device resources for task work according to hardware thresholds including power level, charging status of the device, CPU activity, storage, and network bandwidth;
(d) third means for processing data regarding limiting the use of device resources for tasks submitted by users who share a user-defined geolocation, interests, or group affiliation.

8. The system of claim 7, further comprising tasks that invoke and cache Web service requests.

9. A mobile ad-hoc network (MAN ET) comprising:
(a) a plurality of communication devices, each communication device comprising a computer processor means for processing data, a storage means for storing data on a storage medium, memory, and transceiver;
(b) first means for processing data regarding the exchange of data utilizing multiple means of communication—including but not limited to wired connection, WiFi, Near Field Communication, GPS, and Bluetooth;
(c) second means for processing data regarding routing messages to and from any two communication devices in a resilient manner that overcomes a plurality of service interruption issues such as network segmentation, loss of power, and loss of connectivity due to devices leaving the communication range of other devices, by queueing en-route messages in one or more devices in a routing pathway and forwarding on messages when service connectivity is restored;
(d) third means for processing data regarding transporting data through diffusion of messages as users physically move and encounter other users and establish network connections with them in an ad-hoc manner, enabling messages to be physically couriered by users en-route to their final endpoint destinations.

10. The system of claim 9, further comprising a method for processing data regarding forwarding messages for delivery based on availability of devices operated by users who share like causes, interests, or belong to the same groups as the owner of the forwarding device.

11. The system of claim 9, further comprising a method for processing data regarding forwarding messages for delivery based on availability of devices operated by users who share like causes, interests, or belong to the same groups as the sender of the message.

12. The system of claim 9, further comprising a method for processing data regarding forwarding messages for delivery based on availability of devices operated by users who share like causes, interests, or belong to the same groups as the recipient of the message.

13. The system of claim 9, further comprising a method for processing data regarding forwarding a message for delivery based on availability of devices that are being actively charged (plugged-in).

14. The system of claim 9, further comprising a method for processing data regarding forwarding a message for delivery based on availability of devices sharing particular user-defined resources and levels including CPU, storage, network, power.

15. The system of claim 9, further comprising a method for processing data regarding encrypting messages for delivery to increase privacy of message delivery.

16. The system of claim 9, further comprising a method for processing data regarding connecting to other available networks such as the Internet to deliver messages to and from the MANET and other networks.
